(19) United States
(12) Patent Application Publication
(10) Pub. No.: US 2026/0077761 A1
(43) Pub. Date: Mar. 19, 2026

(54) Vehicle Control Device, Vehicle Control Method, and Vehicle Control System

(71) Applicant: Hitachi Astemo, Ltd., Hitachinaka-shi, Ibaraki (JP)

(72) Inventor: Yuichiro MINAKUCHI, Hitachinaka-shi, Ibaraki (JP)

(21) Appl. No.: 19/110,719

(22) PCT Filed: Dec. 25, 2023
(86) PCT No.: PCT/JP2023/046383

§ 371 Date: Mar. 11, 2025

(30) Foreign Application Priority Data
Nov. 21, 2022 (JP) 2022-185580

(51) Int. Cl. B60W 30/09; B60W 10/04; B60W 10/18; B60W 10/20

(52) U.S. Cl. CPC B60W 30/09; B60W 10/04; B60W 10/18; B60W 10/20; B60W 2510/20; B60W 2520/10; B60W 2530/20; B60W 2710/18; B60W 2710/205; B60W 2710/207

(57) ABSTRACT

According to an aspect of the present invention, a vehicle control device, a vehicle control method, and a vehicle control system obtain a first angle between the orientation of a vehicle and the travel direction of the vehicle, obtain an avoidance course for avoiding an object located ahead of the vehicle, perform first angle control for bringing the first angle closer to a predetermined reference angle when causing the vehicle to follow the avoidance course, and selects either the steering actuator alone or a combination of the steering actuator and at least one of the braking and driving actuators as a control target in the first angle control based on a physical quantity resulting from tire forces of the vehicle. This makes it possible to improve accuracy of tracking the avoidance course.

### TECHNICAL FIELD

The present invention relates to a vehicle control device, to a vehicle control method, and to a vehicle control system.

### BACKGROUND ART

A vehicle control device of Patent Document 1 includes a travel course control unit that updates the target travel course of a vehicle and an automatic emergency avoidance control unit that performs an automatic emergency avoidance control process of automatically activating a predetermined control system to avoid collision with an obstacle.

The travel course control unit calculates multiple corrected travel courses for avoiding an obstacle by correcting the target travel course, evaluates the corrected travel courses using a predetermined evaluation function to select one of the corrected travel courses, and generates a first request signal to cause the vehicle to travel along the selected one of the corrected travel courses. Also, the automatic emergency avoidance control unit generates a second request signal.

### REFERENCE DOCUMENT LIST

### Patent Document

Patent Document 1: Japanese U.S. Pat. No. 6,525,402

### SUMMARY OF THE INVENTION

### Problem to be Solved by the Invention

When the vehicle control device performs course tracking control to cause a vehicle to travel along an avoidance course for avoiding an object located ahead of the vehicle, the accuracy of tracking the avoidance course may decrease if the angle between the orientation of the vehicle and the travel direction of the vehicle is large.

The present invention has been made in view of the above circumstances, and an object of the present invention is to provide a vehicle control device, a vehicle control method, and a vehicle control system that can improve the accuracy of tracking an avoidance course.

### Means for Solving the Problem

According to an aspect of the present invention, a vehicle control device, a vehicle control method, and a vehicle control system obtain a first angle between the orientation of a vehicle and the travel direction of the vehicle, obtain an avoidance course for avoiding an object located ahead of the vehicle, perform first angle control for bringing the first angle closer to a predetermined reference angle when performing course tracking control to cause the vehicle to follow the avoidance course, and select either the steering actuator alone or a combination of at least one of the braking and driving actuators and the steering actuator as a control target in the first angle control based on a physical quantity resulting from tire forces of the vehicle.

### Effects of the Invention

The present invention makes it possible to improve the accuracy of tracking an avoidance course.

### BRIEF DESCRIPTION OF THE DRAWINGS

FIG. 1 is a block diagram illustrating a vehicle control system according to a first embodiment.

FIG. 2 illustrates a collision avoidance assistance operation implemented by a combination of AEB and ESS.

FIG. 3 is a block diagram illustrating a steering assistance requirement calculation unit according to the first embodiment.

FIG. 4 is a block diagram illustrating a β-angle minimization requirement calculation unit according to the first embodiment.

FIG. 5 is a block diagram illustrating a control signal calculation unit according to the first embodiment.

FIG. 6 is a flowchart illustrating a control device selection process according to the first embodiment.

FIG. 7 is a flowchart illustrating the control device selection process according to the first embodiment.

FIG. 8 is a flowchart illustrating the control device selection process according to the first embodiment.

FIG. 9 is a diagram for describing the occurrence of an error in the recognition of a lateral shift amount due to a vehicle slip angle.

FIG. 10 is a diagram for showing that an error in tracking a target course is reduced by decreasing the vehicle slip angle.

FIG. 11 is a diagram illustrating a yaw moment generated by controlling the lateral force of front wheels and the longitudinal force of each wheel.

FIG. 12 is a block diagram illustrating a vehicle control system according to a second embodiment.

FIG. 13 is a block diagram illustrating a control signal calculation unit according to the second embodiment.

FIG. 14 is a flowchart illustrating a control device selection process according to the second embodiment.

FIG. 15 is a flowchart illustrating the control device selection process according to the second embodiment.

FIG. 16 is a flowchart illustrating the control device selection process according to the second embodiment.

FIG. 17 is a block diagram illustrating a vehicle control system according to a third embodiment.

FIG. 18 is a block diagram illustrating a control signal calculation unit according to the third embodiment.

FIG. 19 is a flowchart illustrating a control device selection process according to the third embodiment.

FIG. 20 is a flowchart illustrating the control device selection process according to the third embodiment.

FIG. 21 is a block diagram illustrating a vehicle control system according to a fourth embodiment.

FIG. 22 is a flowchart illustrating a control device selection process according to the fourth embodiment.

FIG. 23 is a flowchart illustrating the control device selection process according to the fourth embodiment.

FIG. 24 is a flowchart illustrating the control device selection process according to the fourth embodiment.

### MODE FOR CARRYING OUT THE INVENTION

Vehicle control devices, vehicle control methods, and vehicle control systems according to embodiments of the present invention are described below with reference to the drawings.

### First Embodiment

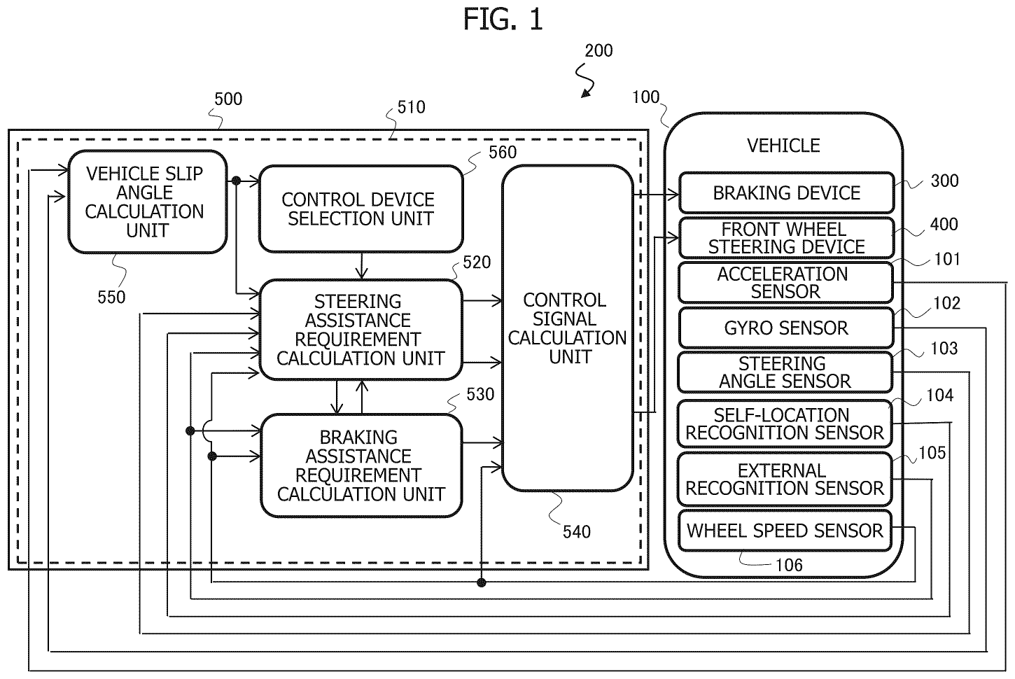

FIG. 1 is a block diagram illustrating an example of a vehicle control system 200 installed in a vehicle 100, such as a four-wheeled automobile.

As described in detail later, vehicle control system 200 performs collision avoidance assistance.

Vehicle control system 200 includes a braking device 300 that applies a braking force to each of wheels (a pair of front wheels and a pair of rear wheels) of vehicle 100, a front wheel steering device 400 that steers the front wheels of vehicle 100, and a vehicle control device 500 provided in vehicle 100.

Braking device 300 includes an actuator that can individually control the braking force applied to each wheel according to an electrical signal.

Front wheel steering device 400 includes an actuator that can control the steering angle of the front wheels according to an electrical signal.

Braking device 300 is a braking actuator that applies a braking force to each wheel of vehicle 100 and is one of braking and driving actuators that apply braking and driving forces to the wheels of the vehicle 100.

That is, in the present application, braking and driving actuators include a braking actuator and a driving actuator, and braking device 300 corresponds to a braking actuator among the braking and driving actuators.

Also, front wheel steering device 400 is a front wheel steering actuator that steers the front wheels of vehicle 100 among steering actuators that steer the wheels of vehicle 100.

Vehicle control device 500 includes a microcomputer 510 as a control unit that performs calculations based on input information and outputs calculation results.

The microcomputer 510 includes a microprocessor unit (MPU), a read-only memory (ROM), and a random access memory (RAM) (not shown).

Microcomputer 510 may also be referred to as a micro controller unit (MCU), a processor, a processing device, or an arithmetic device.

Vehicle 100 includes various sensors for detecting vehicle conditions, and microcomputer 510 obtains signals output from the various sensors.

As the various sensors, vehicle 100 includes an acceleration sensor 101, a gyro sensor 102, a steering angle sensor 103, a self-location recognition sensor 104, an external recognition sensor 105, and a wheel speed sensor 106.

Acceleration sensor 101 detects acceleration in the motion of vehicle 100, such as longitudinal acceleration, lateral acceleration (in other words, acceleration in the right and left directions), and vertical acceleration of vehicle 100.

Gyro sensor 102 detects angular velocities in the motion of vehicle 100, such as yaw rate, roll rate, and pitch rate of vehicle 100.

Steering angle sensor 103 detects a steering angle θ corresponding to an operation performed by the driver of vehicle 100.

Self-location recognition sensor 104 includes a GPS receiver that measures the latitude and the longitude of the position of vehicle 100 by, for example, receiving signals from GPS satellites, and detects the position of vehicle 100.

External recognition sensor 105 obtains external information of vehicle 100, in other words, information regarding the driving environment of a driving road on which vehicle 100 travels, and includes, for example, a camera, a radar, and a LiDAR (Light Detection and Ranging, Laser Imaging Detection and Ranging) device.

Wheel speed sensor 106 detects the rotational speed of each wheel of vehicle 100.

Microcomputer 510 includes a function to perform collision avoidance assistance to avoid a collision with an object (hereafter referred to as an obstacle) located in the forward travel direction of vehicle 100 or to reduce collision damage.

As collision avoidance assistance, microcomputer 510 performs autonomous emergency braking (AEB), which automatically activates braking device 300 based on a collision risk, and emergency steering support (ESS), which causes vehicle 100 to follow an avoidance course automatically generated in response to an avoidance maneuver performed by the driver of vehicle 100.

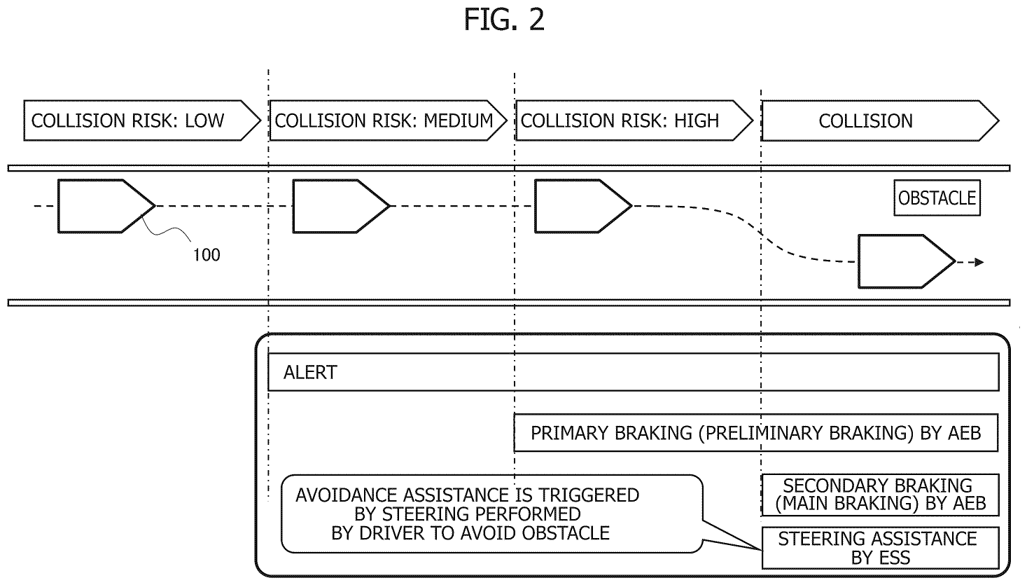

FIG. 2 illustrates the transition of a collision avoidance assistance operation implemented by a combination of AEB and ESS.

In the collision avoidance assistance operation implemented by a combination of AEB and ESS, microcomputer 510 gradually strengthens collision avoidance assistance in the order of “alert to driver”, “primary braking (preliminary braking) by AEB”, “secondary braking (main braking) by AEB”, and “steering assistance by ESS” as the risk of collision with an obstacle recognized by external recognition sensor 105 increases.

In the embodiment described below, it is assumed that the intervention timing of “steering assistance by ESS” is the same as the intervention timing of “secondary braking (main braking) by AEB”. However, the intervention timing of “steering assistance by ESS” may be different from the intervention timing of “secondary braking (main braking) by AEB”.

In other words, the intervention timing of “steering assistance by ESS” may be set independently of the intervention timing of “primary braking (preliminary braking) by AEB” and the intervention timing of “secondary braking (main braking) by AEB”.

FIG. 1 illustrates functional blocks for the collision avoidance assistance described above.

Microcomputer 510 includes functional units including a steering assistance requirement calculation unit 520 providing the function of ESS, a braking assistance requirement calculation unit 530 providing the function of AEB, a control signal calculation unit 540, a vehicle slip angle calculation unit 550, and a control device selection unit 560.

Control signal calculation unit 540 obtains a required steering assistance value output by steering assistance requirement calculation unit 520 and a required braking assistance value output by braking assistance requirement calculation unit 530, and calculates braking control signals for the respective wheels and a front wheel steering control signal based on the obtained values.

Control signal calculation unit 540 then outputs the braking control signals to braking device 300 and outputs the front wheel steering control signal to front wheel steering device 400.

When braking device 300 is configured to generate braking forces corresponding to control currents, control signal calculation unit 540 may output braking control currents as the braking control signals.

Similarly, when front wheel steering device 400 is configured to generate a steering force corresponding to a control current, control signal calculation unit 540 may output a front wheel steering control current as the front wheel steering control signal.

Vehicle slip angle calculation unit 550 calculates a first angle (hereafter referred to as a vehicle slip angle β) between the orientation of vehicle 100 and the travel direction of vehicle 100.

Vehicle slip angle calculation unit 550 obtains information on longitudinal acceleration and lateral acceleration detected by acceleration sensor 101 and information on a yaw rate detected by gyro sensor 102 and performs a calculation process based on the obtained information to estimate vehicle slip angle β.

Steering assistance requirement calculation unit 520 includes a course tracking control function (in other words, an ESS function) that generates an avoidance course for avoiding an obstacle in response to a steering operation performed by the driver and calculates a required steering value for causing vehicle 100 to follow the avoidance course.

Also, steering assistance requirement calculation unit 520 includes a vehicle slip angle control function that, when causing vehicle 100 to follow the avoidance course, calculates a required steering value and a required braking value for generating a yaw moment necessary to bring vehicle slip angle β closer to a predetermined reference angle βTH.

Control device selection unit 560 obtains a signal indicating vehicle slip angle β from vehicle slip angle calculation unit 550 and outputs, to steering assistance requirement calculation unit 520, a control device selection signal that specifies a control target in vehicle slip angle control.

Based on vehicle slip angle β, control device selection unit 560 selects either front wheel steering device 400 alone, or both braking device 300 and front wheel steering device 400, as the control target of the vehicle slip angle control function.

In other words, control device selection unit 560 includes a function that selects either the steering actuator alone, or both the braking and driving actuators and the steering actuator, as the control target in vehicle slip angle control based on vehicle slip angle β that is a physical quantity resulting from tire forces.

As an example of a course tracking control method, there is a control method that feeds back a lateral position deviation between the predicted vehicle position and the target course at the preview point.

In the case of collision avoidance, as vehicle slip angle β increases, the error in the predicted vehicle position at the preview point increases and the tracking error from the target course increases.

For this reason, when performing course tracking control for causing vehicle 100 to follow an avoidance course, steering assistance requirement calculation unit 520 performs vehicle slip angle control to reduce vehicle slip angle β and thereby improve the accuracy of tracking the avoidance course.

Furthermore, with the function of control device selection unit 560 for selecting the control target in vehicle slip angle control according to vehicle slip angle β, it is possible to select the control target considering the tire forces of the wheels required to obtain a yaw moment necessary to reduce vehicle slip angle B and the limit of the tire forces of the wheels and to stably achieve the minimization of vehicle slip angle β in various situations.

Therefore, microcomputer 510 can cause vehicle 100 to accurately follow the avoidance course in various situations and can implement the steering assistance function for collision avoidance at a high level.

The functional blocks illustrated in FIG. 1 are described in detail below.

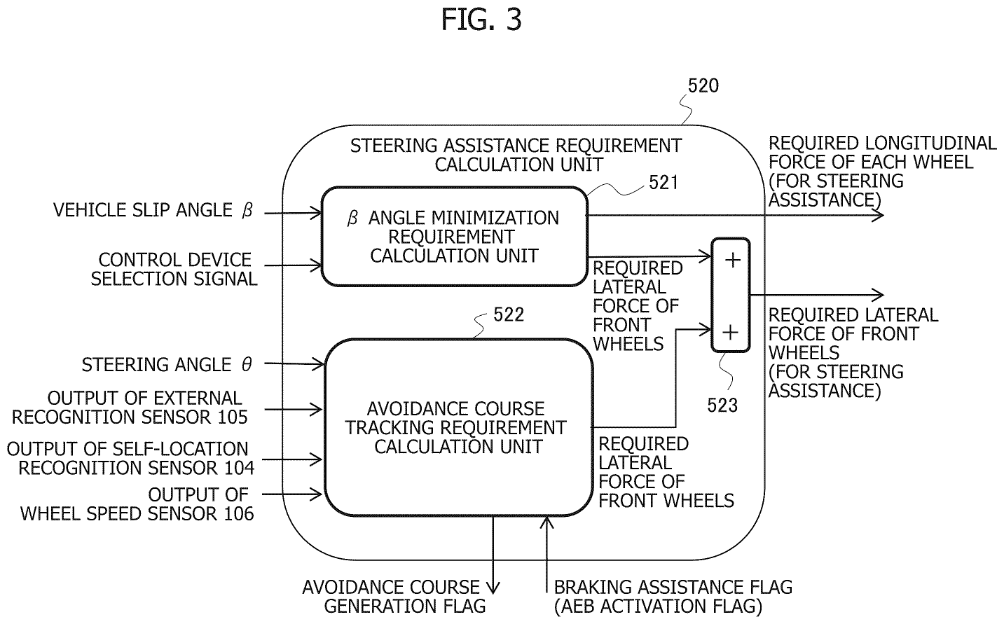

FIG. 3 is a functional block diagram illustrating the details of steering assistance requirement calculation unit 520.

Steering assistance requirement calculation unit 520 includes a β-angle minimization requirement calculation unit 521, an avoidance course tracking requirement calculation unit 522, and an adding unit 523.

Avoidance course tracking requirement calculation unit 522 obtains information on steering angle θ detected by steering angle sensor 103, an external recognition state (specifically, information on the position and the size of an obstacle) detected by external recognition sensor 105, positional information of vehicle 100 detected by self-location recognition sensor 104, and information on the wheel speed (in other words, information on the vehicle speed) detected by wheel speed sensor 106.

Also, avoidance course tracking requirement calculation unit 522 obtains a signal representing a braking assistance flag indicating the operation state of AEB from braking assistance requirement calculation unit 530 and outputs a signal representing an avoidance course generation flag indicating the generation state of the avoidance course (in other words, the operation state of ESS) to braking assistance requirement calculation unit 530.

Then, when AEB is in a secondary braking state, avoidance course tracking requirement calculation unit 522 generates an avoidance course for avoiding the obstacle based on the positional relationship between vehicle 100 and the obstacle, the speed of vehicle 100, and steering angle θ (in other words, information on avoidance steering performed by the driver).

As described above, the steering assistance requirement calculation unit 520 can set the intervention timing of steering assistance independently of the activation of AEB by braking assistance requirement calculation unit 530.

In this case, avoidance course tracking requirement calculation unit 522 independently determines the intervention timing based on an indicator, such as a collision risk, and generates an avoidance course. Therefore, it is possible to omit the transfer of the signal representing the braking assistance flag and the signal representing the avoidance course generation flag between avoidance course tracking requirement calculation unit 522 and braking assistance requirement calculation unit 530.

After generating the avoidance course, avoidance course tracking requirement calculation unit 522 calculates a lateral position deviation Δy between the predicted vehicle position and the avoidance course at the preview point (in other words, an error in tracking the avoidance course).

Next, based on the lateral position deviation Δy, avoidance course tracking requirement calculation unit 522 calculates and outputs a required lateral force of the front wheels (in other words, a required lateral force for steering assistance or a required lateral force for ESS) required to cause vehicle 100 to follow the avoidance course.

β-angle minimization requirement calculation unit 521 is a functional unit that performs vehicle slip angle control.

β-angle minimization requirement calculation unit 521 obtains vehicle slip angle β and the control device selection signal and outputs, for steering assistance, the required lateral force of the front wheels and the required longitudinal forces of the respective wheels that are used to generate a yaw moment necessary to bring vehicle slip angle β closer to reference angle βTH.

Adding unit 523 obtains the required lateral force of the front wheels output by avoidance course tracking requirement calculation unit 522 and the required lateral force of the front wheels output by β-angle minimization requirement calculation unit 521 and outputs the sum of the required lateral forces to control signal calculation unit 540 as a required lateral force of the front wheels for steering assistance.

On the other hand, the required longitudinal forces of the respective wheels output by β-angle minimization requirement calculation unit 521 are output without change to control signal calculation unit 540 as required longitudinal forces of the respective wheels for steering assistance.

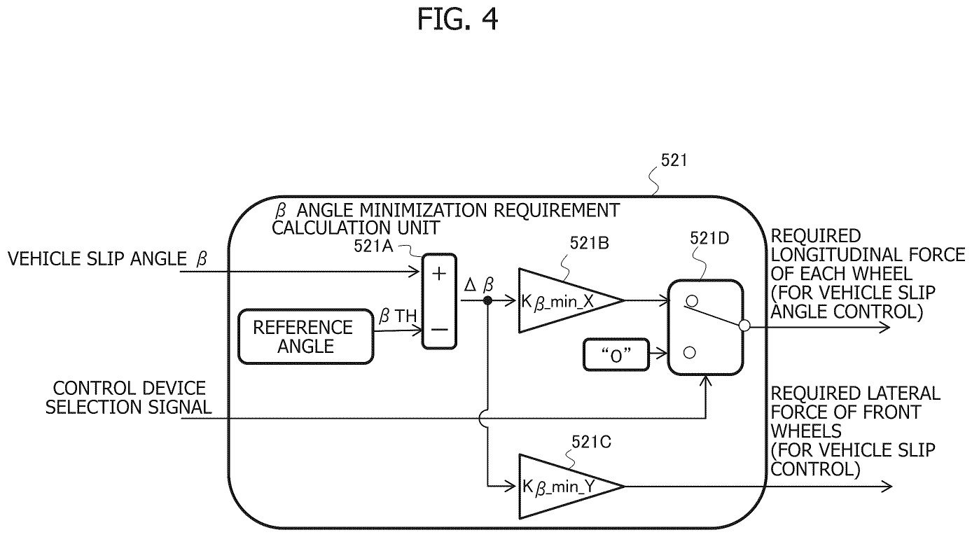

FIG. 4 is a functional block diagram illustrating details of β-angle minimization requirement calculation unit 521.

β-angle minimization requirement calculation unit 521 includes a comparison unit 521A, a first conversion unit 521B, a second conversion unit 521C, and a longitudinal force output switching unit 521D.

Comparison unit 521A obtains information on vehicle slip angle β [deg] calculated by vehicle slip angle calculation unit 550 and information on reference angle βTH [deg], calculates a deviation Δβ [deg] between vehicle slip angle β and reference angle βTH, and outputs information on calculated deviation αβ.

First conversion unit 521B obtains the information on deviation Δβ and converts deviation Δβ into required longitudinal forces of the respective wheels.

That is, first conversion unit 521B obtains required longitudinal forces required for the respective wheels to generate a yaw moment that is necessary to make vehicle slip angle β match reference angle βTH.

Second conversion unit 521C obtains the information on deviation Δβ and converts deviation Δβ to a required lateral force of the front wheels.

That is, second conversion unit 521C obtains a required lateral force that is required for the front wheels to generate a yaw moment necessary to make vehicle slip angle β match reference angle βTH.

Reference angle βTH obtained by comparison unit 521A is set to zero or a value close to zero.

When reference angle βTH is zero, comparison unit 521A outputs vehicle slip angle β calculated by vehicle slip angle calculation unit 550 without change.

Accordingly, when reference angle βTH is zero, first conversion unit 521B and second conversion unit 521C calculate the longitudinal forces of the respective wheels and the lateral force of the front wheels that are required to generate a yaw moment necessary to bring vehicle slip angle β to zero.

Longitudinal force output switching unit 521D obtains information on the required longitudinal forces of the respective wheels obtained by first conversion unit 521B and the control device selection signal output by control device selection unit 560.

Here, the control device selection signal is set to a binary signal.

A control device selection signal representing “1” indicates that both of braking device 300 and front wheel steering device 400 are selected as the control target in vehicle slip angle control.

On the other hand, a control device selection signal representing “0” indicates that only front wheel steering device 400 is selected as the control target in vehicle slip angle control.

When the control device selection signal represents 1 and braking device 300 is included as the control target in vehicle slip angle control, longitudinal force output switching unit 521D outputs information on the required longitudinal forces of the respective wheels obtained by first conversion unit 521B as required longitudinal forces (more specifically, required braking values) of the respective wheels for vehicle slip angle control.

When the control device selection signal represents 0 and braking device 300 is not included as the control target in vehicle slip angle control, longitudinal force output switching unit 521D outputs 0 as the required longitudinal force of each wheel for vehicle slip angle control.

In other words, longitudinal force output switching unit 521D determines whether to add braking device 300 as the control target in vehicle slip angle control by switching between outputting the required longitudinal force of each wheel obtained by first conversion unit 521B without change and outputting the required longitudinal force of each wheel as zero based on the control device selection signal.

Then, the required longitudinal force of each wheel for vehicle slip angle control output by longitudinal force output switching unit 521D is output from steering assistance requirement calculation unit 520 without change as the required longitudinal force of each wheel for steering assistance.

On the other hand, the required lateral force of the front wheels for vehicle slip angle control obtained by second conversion unit 521C is output to adding unit 523 and is added to the required lateral force of the front wheels obtained by avoidance course tracking requirement calculation unit 522.

Adding unit 523 outputs the result of addition to control signal calculation unit 540 as a required lateral force for steering assistance.

Braking assistance requirement calculation unit 530 illustrated in FIG. 1 obtains an output (in other words, external recognition information) of external recognition sensor 105, an output (in other words, information on the speed of vehicle 100) of the wheel speed sensor, and a signal representing the avoidance course generation flag output by steering assistance requirement calculation unit 520.

Then, braking assistance requirement calculation unit 530 calculates and outputs required longitudinal forces (in other words, required longitudinal forces for braking assistance or required longitudinal forces for AEB) of the respective wheels required for collision avoidance or collision damage reduction.

That is, braking assistance requirement calculation unit 530 automatically generates braking forces for collision avoidance or collision damage reduction by detecting an obstacle, such as an automobile or an object ahead of vehicle 100, by using external recognition sensor 105, such as a camera or a radar.

Also, braking assistance requirement calculation unit 530 outputs a signal representing a braking assistance flag, which indicates an operation state of AEB, to steering assistance requirement calculation unit 520.

Here, when steering assistance requirement calculation unit 520 is configured to independently set the intervention timing of steering assistance, the output of the braking assistance flag from braking assistance requirement calculation unit 530 to steering assistance requirement calculation unit 520 may be omitted.

Control signal calculation unit 540 obtains signals representing required longitudinal forces for steering assistance and a required lateral force for steering assistance from steering assistance requirement calculation unit 520 and also obtains signals representing required longitudinal forces for braking assistance from braking assistance requirement calculation unit 530.

Furthermore, control signal calculation unit 540 obtains an output (in other words, information on the speed of vehicle 100) from the wheel speed sensor.

Then, control signal calculation unit 540 outputs braking control signals for the respective wheels to braking device 300 and outputs a steering control signal for the front wheels to front wheel steering device 400.

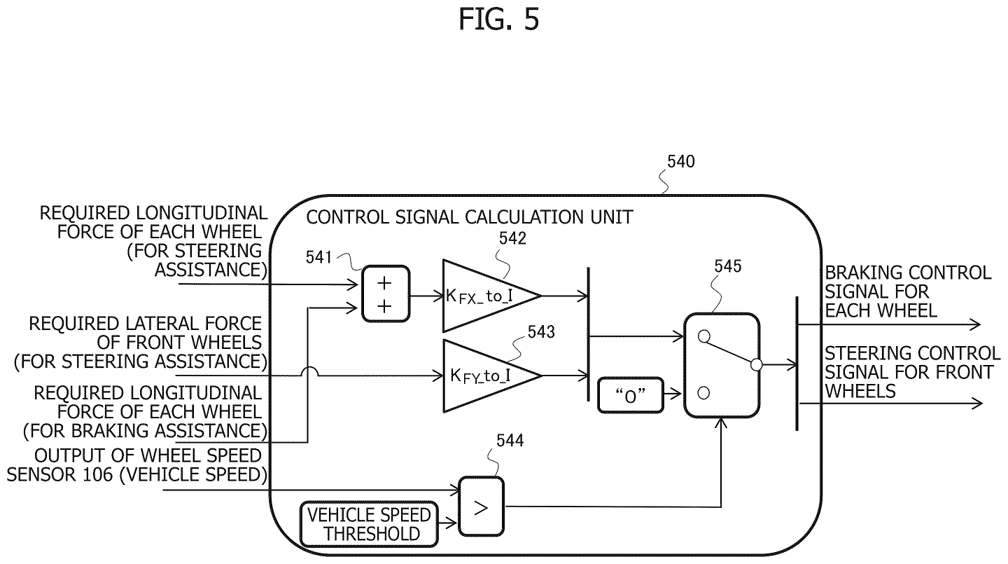

FIG. 5 is a block diagram illustrating details of control signal calculation unit 540.

An adding unit 541 obtains a signal representing a required longitudinal force for steering assistance and a signal representing a required longitudinal force for braking assistance and outputs the sum of these signals as a signal representing a final required longitudinal force for collision avoidance assistance.

A first conversion unit 542 converts the signal representing the required longitudinal force for collision avoidance assistance output by adding unit 541 into a braking control signal for each wheel.

A second conversion unit 543 obtains a signal representing a required lateral force of the front wheels for steering assistance and converts the signal representing the required lateral force of the front wheels for steering assistance into a steering control signal for the front wheels.

A comparison unit 544 obtains a signal representing a vehicle speed that is based on the output of wheel speed sensor 106, compares the obtained signal representing the vehicle speed with a threshold, and outputs a switching signal for switching between outputting and not outputting required values for collision avoidance assistance.

Switching unit 545 obtains the braking control signal for each wheel output by first conversion unit 542, the steering control signal for the front wheels output by second conversion unit 543, and the switching signal output by comparison unit 544.

Then, based on the switching signal, switching unit 545 switches between outputting and not outputting the braking control signal for each wheel, which is output from first conversion unit 542, and the steering control signal for the front wheels, which is output from second conversion unit 543, to the downstream devices (braking device 300 and front wheel steering device 400).

Here, in a slow state in which the vehicle speed is less than or equal to a threshold, switching unit 545 stops outputting the braking control signal for each wheel, which is output from first conversion unit 542, and the steering control signal for the front wheels, which is output from second conversion unit 543, to the downstream devices by setting the braking control signal to be output to braking device 300 and the steering control signal to be output to front wheel steering device 400 to zero.

On the other hand, when the vehicle speed is greater than the threshold, switching unit 545 outputs the braking control signal for each wheel, which is output from first conversion unit 542, and the steering control signal for the front wheels, which is output from second conversion unit 543, to braking device 300 and front wheel steering device 400 without change.

Thus, when the vehicle speed is substantially low and the effectiveness of collision avoidance assistance is low, control signal calculation unit 540 stops braking control and steering control for collision avoidance assistance.

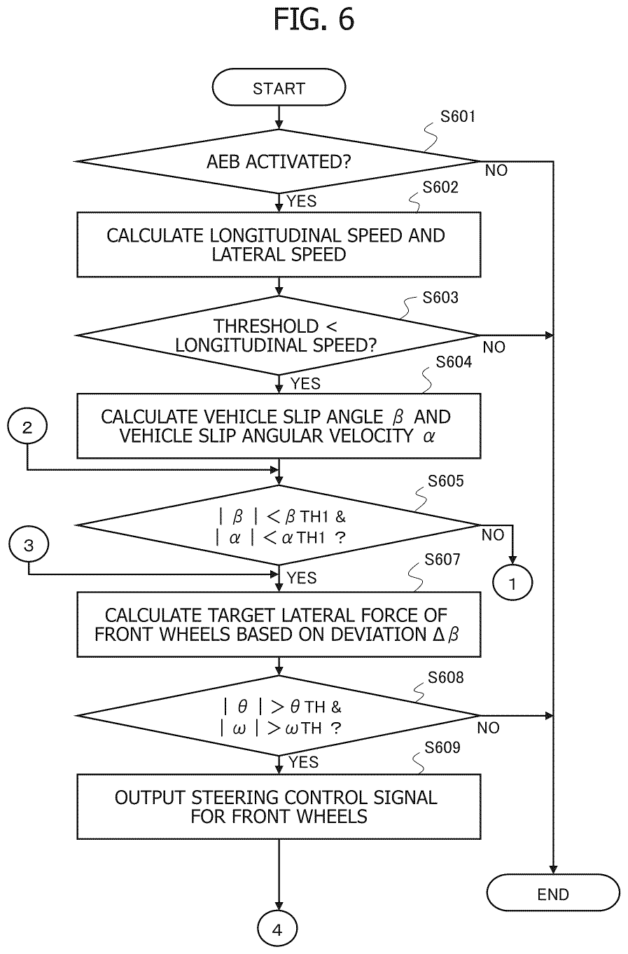

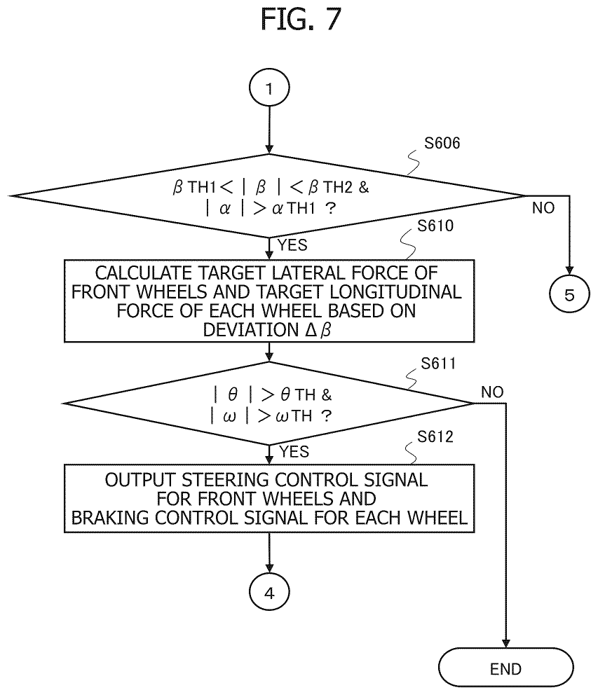

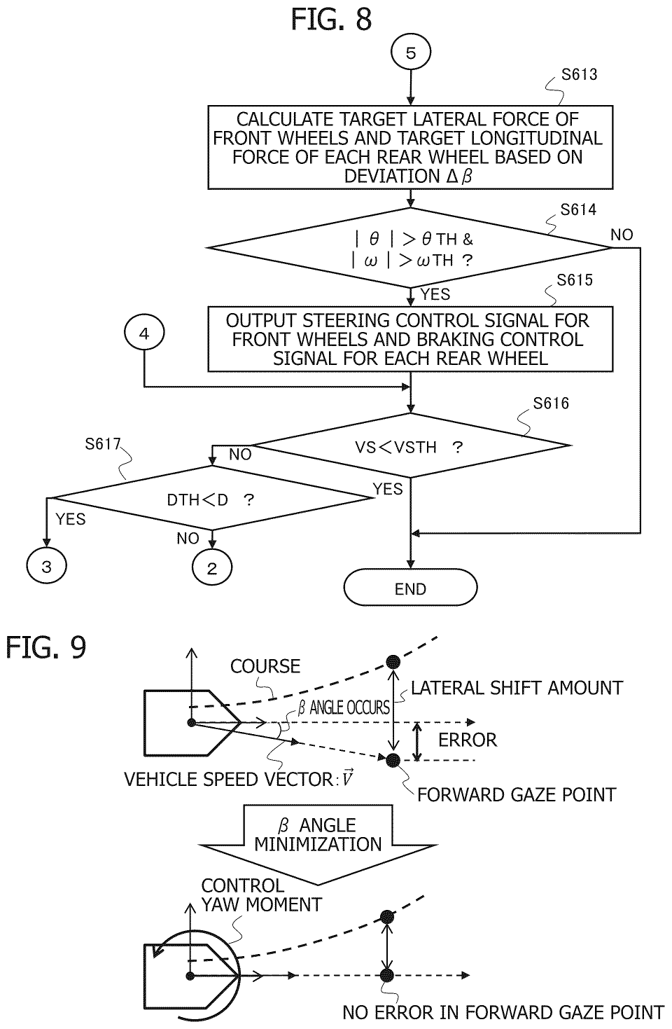

Flowcharts in FIGS. 6-8 illustrate a control target selection process performed by control device selection unit 560 and a vehicle slip angle control process performed by β-angle minimization requirement calculation unit 521.

At step S601, microcomputer 510 determines whether the collision risk has been determined to be high based on the output of external recognition sensor 105 and whether braking assistance by AEB has been activated.

When AEB has been activated, microcomputer 510 proceeds to step S602 and subsequent steps because there is a possibility that ESS is triggered by a steering operation performed by the driver.

On the other hand, when AEB has not been activated, microcomputer 510 ends this routine because the prerequisite for activating ESS is not satisfied.

Here, when steering assistance requirement calculation unit 520 is configured to independently set the intervention timing of steering assistance, microcomputer 510 at step S601 independently determines a precondition for activating ESS based on an indicator, such as a collision risk.

At step S602, microcomputer 510 calculates the longitudinal speed [km/h] and the lateral speed [km/h] of vehicle 100 based on an output of acceleration sensor 101 and an output of gyro sensor 102.

Next, at step S603, microcomputer 510 determines whether the longitudinal speed obtained at step S602 is greater than a threshold.

When the longitudinal speed is less than or equal to the threshold, microcomputer 510 determines that the condition for estimating vehicle slip angle β is not satisfied, in other words, determines that vehicle slip angle control cannot be performed because the accuracy of estimating vehicle slip angle β cannot be ensured, and ends this routine.

On the other hand, when the longitudinal speed is greater than the threshold, microcomputer 510 proceeds to step S604.

At step S604, microcomputer 510 calculates vehicle slip angle β based on detection values, such as a vehicle speed, a yaw rate, and lateral acceleration, and also calculates a vehicle slip angular velocity α by taking the time derivative of vehicle slip angle β.

In other words, when the longitudinal speed is greater than the threshold, microcomputer 510 obtains vehicle slip angle β and vehicle slip angular velocity α, which are physical quantities resulting from the tire forces of vehicle 100.

Microcomputer 510 calculates vehicle slip angle β and vehicle slip angular velocity α as values with signs indicating left and right directions.

Next, at step S605, microcomputer 510 determines whether the absolute value of vehicle slip angle β is less than a first threshold βTH1 (βTH1>0) and whether the absolute value of vehicle slip angular velocity α is less than a threshold αTH1 (αTH1>0).

In other words, microcomputer 510 determines at step S605 whether vehicle slip angle β is a sufficiently small value that is less than the threshold and whether vehicle slip angle βis decreasing.

When determining, at step S605, that the absolute value of vehicle slip angle β is less than first threshold βTH1 and the absolute value of vehicle slip angular velocity α is less than threshold αTH1, microcomputer 510 proceeds to step S607.

At step S607, microcomputer 510 calculates the required lateral force of the front wheels that is required to generate a yaw moment necessary to bring vehicle slip angle β closer to reference angle βTH (for example, βTH=0 [deg]) based on a deviation Δβ between vehicle slip angle β and reference angle βTH.

That is, a state in which the absolute value of vehicle slip angle β is less than first threshold βTH1 and the absolute value of vehicle slip angular velocity α is less than threshold αTH1 is a state in which a yaw moment necessary to bring vehicle slip angle β closer to reference angle βTH can be generated solely by the steering control of the front wheels.

Therefore, in the state in which the absolute value of vehicle slip angle β is less than first threshold βTH1 and the absolute value of vehicle slip angular velocity α is less than threshold αTH1, microcomputer 510 selects only front wheel steering device 400 as the control target in vehicle slip angle control.

Next, microcomputer 510 proceeds to step S608 to determine whether the absolute value of steering angle θ performed by the driver is greater than a threshold θTH and whether the absolute value of a steering angular velocity ω calculated by taking the time derivative of steering angle θ is greater than a threshold ωTH.

Here, step S608 is a process of determining whether a steering operation is performed by the driver as a trigger to start the operation of ESS.

Microcomputer 510 determines that the conditions for activating ESS are satisfied when the absolute value of steering angle θ is greater than threshold θTH and the absolute value of steering angular velocity ω is greater than threshold ωTH, and proceeds to step S609.

At step S609, microcomputer 510 outputs a steering control signal for the front wheels based on the required lateral force of the front wheels for vehicle slip angle control that is calculated at step S607.

On the other hand, when determining at step S608 that the conditions, defining that the absolute value of steering angle θ is greater than threshold θTH and steering angular velocity ω is greater than threshold ωTH, are not satisfied, microcomputer 510 determines that the conditions for activating ESS are not satisfied and ends this routine without performing vehicle slip angle control.

When determining at step S605 that the conditions, defining that the absolute value of vehicle slip angle β is less than first threshold βTH1 and the absolute value of vehicle slip angular velocity α is less than threshold αTH1, are not satisfied, microcomputer 510 proceeds to step S606.

At step S606, microcomputer 510 determines whether the absolute value of vehicle slip angle β is greater than first threshold βTH1 and is less than a second threshold βTH2 (βTH2>βTH1>0), and whether the absolute value of vehicle slip angular velocity α is greater than threshold αTH1.

In other words, microcomputer 510 determines at step S606 whether vehicle slip angle β is within a predetermined range not including zero and is on the increase.

When determining at step S606 that the absolute value of vehicle slip angle β is greater than first threshold βTH1 and is less than second threshold βTH2 and the absolute value of vehicle slip angular velocity α is greater than threshold αTH1, microcomputer 510 proceeds to step S610.

At step S610, microcomputer 510 calculates the required lateral force of the front wheels and the required longitudinal force (required braking force) of each wheel that are required to generate a yaw moment necessary to bring vehicle slip angle β closer to reference angle βTH based on deviation Δβ between vehicle slip angle β and reference angle βTH.

The state in which the absolute value of vehicle slip angle β is greater than first threshold βTH1 and is less than second threshold βTH2 and the absolute value of vehicle slip angular velocity α is greater than threshold αTH1 corresponds to a state in which the control of the longitudinal force of each wheel is necessary in addition to the steering control of the front wheels to generate a yaw moment necessary to bring vehicle slip angle β closer to reference angle βTH.

Therefore, in the state in which the absolute value of vehicle slip angle β is greater than first threshold βTH1 and is less than second threshold βTH2, and the absolute value of vehicle slip angular velocity α is greater than threshold αTH1, microcomputer 510 selects both of front wheel steering device 400 and braking device 300 as the control target in vehicle slip angle control.

Next, microcomputer 510 proceeds to step S611 and determines, similarly to step S608, whether steering angle θ is greater than threshold θTH and steering angular velocity ω is greater than threshold ωTH.

When steering angle θ is greater than threshold θTH and steering angular velocity ω is greater than threshold ωTH, microcomputer 510 proceeds to step S612.

At step S612, microcomputer 510 outputs a steering control signal for the front wheels based on the required lateral force of the front wheels for vehicle slip angle control and also outputs a braking control signal for each wheel based on the required longitudinal force of the corresponding wheel for vehicle slip angle control.

On the other hand, when determining at step S611 that the conditions, defining that steering angle θ is greater than threshold θTH and steering angular velocity ω is greater than threshold ωTH, are not satisfied, microcomputer 510 ends this routine without performing vehicle slip angle control.

Also, when determining at step S606 that the conditions, defining that the absolute value of vehicle slip angle β is greater than first threshold βTH1 and is less than second threshold βTH2 and the absolute value of vehicle slip angular velocity α is greater than threshold αTH1, are not satisfied, microcomputer 510 proceeds to step S613.

At step S613, based on deviation Δβ between vehicle slip angle β and reference angle βTH, microcomputer 510 calculates a required lateral force of the front wheels and a required longitudinal force (required braking force) of each rear wheel that are required to generate a yaw moment necessary to bring vehicle slip angle β closer to reference angle βTH.

When microcomputer 510 determines at step S606 that the conditions, defining that the absolute value of vehicle slip angle β is greater than first threshold βTH1 and is less than second threshold βTH2 and the absolute value of vehicle slip angular velocity α is greater than threshold αTH1, are not satisfied, it is assumed that the lateral force of the front tires is saturated and there is no margin to generate a tire longitudinal force.

In this case, microcomputer 510 excludes the front wheels from the target of longitudinal force control in vehicle slip angle control and controls the longitudinal force of each rear wheel in vehicle slip angle control.

Switching the control target as described above makes it possible to prevent an unstable control state.

In other words, when determining at step S606 that the conditions, defining that the absolute value of vehicle slip angle β is greater than first threshold βTH1 and is less than second threshold βTH2 and the absolute value of vehicle slip angular velocity α is greater than threshold αTH1, are not satisfied, microcomputer 510 selects front wheel steering device 400 (front wheel steering actuator) and braking device 300 (rear wheel braking actuator) for the rear wheels as the control target in vehicle slip angle control.

Next, microcomputer 510 proceeds to step S614 and, similarly to step S608, determines whether steering angle θ of steering performed by the driver is greater than threshold θTH and whether steering angular velocity ω calculated by taking the time derivative of steering angle 0 is greater than threshold ωTH.

When steering angle θ is greater than threshold θTH and steering angular velocity ω is greater than threshold ωTH, microcomputer 510 proceeds to step S615.

At step S615, microcomputer 510 outputs a steering control signal for the front wheels based on the required lateral force of the front wheels for vehicle slip angle control and also outputs a braking control signal for each rear wheel based on the required longitudinal force of the corresponding rear wheel for vehicle slip angle control.

On the other hand, when determining at step S614 that the conditions, defining that steering angle θ is greater than threshold θTH and steering angular velocity ω is greater than threshold ωTH, are not satisfied, microcomputer 510 ends this routine without performing vehicle slip angle control.

After performing step S609, S612, or S615, microcomputer 510 proceeds to step S616 and compares vehicle speed VS, which is obtained based on the output of wheel speed sensor 106, with a threshold VSTH.

Here, threshold VSTH indicates vehicle speed VS used as a condition for terminating ESS.

Microcomputer 510 ends vehicle slip angle control when vehicle speed VS is less than threshold VSTH.

On the other hand, microcomputer 510 proceeds to step S617 when vehicle speed VS is greater than or equal to threshold VSTH and ESS is continued.

At step S617, microcomputer 510 determines whether a distance D from vehicle 100 to the obstacle ahead is greater than a threshold DTH.

Here, when distance D to the obstacle is greater than threshold DTH, it indicates that the margin for collision avoidance control is large and the requirement for the accuracy of tracking the avoidance course is relatively low.

Therefore, when determining at step S617 that distance D to the obstacle is greater than threshold DTH, microcomputer 510 proceeds to step S607 and brings vehicle slip angle β closer to reference angle βTH solely by controlling front wheel steering device 400.

In other words, when distance D to the obstacle is greater than threshold DTH, microcomputer 510 selects only front wheel steering device 400 as the control target for vehicle slip angle control regardless of the conditions of vehicle slip angle β and vehicle slip angular velocity α.

On the other hand, when distance D to the obstacle is less than or equal to threshold DTH, it indicates that the margin for collision avoidance control is small. Therefore, it is necessary to quickly bring vehicle slip angle β closer to reference angle βTH and improve the performance in tracking the avoidance course.

Therefore, when determining at step S617 that distance D to the obstacle is less than or equal to threshold DTH, microcomputer 510 proceeds to step S605 to select the control target based on vehicle slip angle β and vehicle slip angular velocity α.

Here, first threshold βTH1 and second threshold βTH2 of vehicle slip angle β and threshold αTH1 of vehicle slip angular velocity α, which are used by microcomputer 510 in the control target selection process, are set as described below.

First threshold βTH1 of vehicle slip angle β and threshold αTH1 of vehicle slip angular velocity α depend on a course tracking control logic and are affected, for example, by a preview distance (preview distance=preview time/vehicle speed) in the case of preview control.

Therefore, first threshold βTH1 of vehicle slip angle β and threshold αTH1 of vehicle slip angular velocity α are adjusted according to a course tracking control logic, e.g., according to the set value of the preview distance.

Also, second threshold βTH2 of vehicle slip angle β is affected by factors that affect the tire friction circle (in other words, tire grip limit).

Therefore, second threshold βTH2 of vehicle slip angle β is adjusted according to factors that affect the tire friction circle.

Factors affecting the tire friction circle include, for example, a vertical load, a tire type such as a summer tire or a winter tire, a tire air pressure or temperature, a tire wear amount, and the friction coefficient of a road surface.

When changing second threshold βTH2 according to the vertical load, microcomputer 510 may estimate information on the vertical load based on, for example, an output of acceleration sensor 101 and an output of gyro sensor 102 and increase second threshold βTH2 as the vertical load increases.

Also, when changing second threshold βTH2 according to the tire type, microcomputer 510 may obtain information on the tire type from, for example, the user of vehicle 100. When vehicle 100 is fitted with summer tires (in other words, standard tires), microcomputer 510 may set second threshold βTH2 to a higher value compared with a case in which vehicle 100 is fitted with winter tires (for example, studless tires).

Also, when changing second threshold βTH2 according to the tire air pressure or temperature, microcomputer 510 may obtain information on the tire air pressure or temperature from, for example, a sensor and may increase second threshold βTH2 as the tire air pressure or temperature increases.

When changing second threshold βTH2 according to the tire wear amount, microcomputer 510 may estimate a tire slip ratio based on, for example, outputs from acceleration sensor 101 and gyro sensor 102, estimate the tire wear amount based on the tire slip ratio, and increase second threshold βTH2 as the tire wear amount increases.

Furthermore, when changing second threshold βTH2 according to the friction coefficient of a road surface, microcomputer 510 may estimate a tire slip ratio based on, for example, outputs from acceleration sensor 101 and gyro sensor 102, estimate the friction coefficient of the road surface based on the tire slip ratio, and increase second threshold βTH2 as the friction coefficient of the road surface increases.

According to the collision avoidance assistance of the first embodiment described above, when ESS is performed to cause vehicle 100 to follow an avoidance course, microcomputer 510 performs steering control and braking control to reduce vehicle slip angle β. This makes it possible to improve the performance in tracking the avoidance course and thereby improve the performance in collision avoidance and damage reduction.

Also, microcomputer 510 selects the control target based on information on vehicle slip angle β and vehicle slip angular velocity α in vehicle slip angle control for reducing vehicle slip angle β.

Thus, microcomputer 510 can switch the control target considering the tire forces of each wheel for obtaining a yaw moment necessary to reduce vehicle slip angle β and the tire force limit.

Accordingly, microcomputer 510 can effectively reduce vehicle slip angle β and stably increase the accuracy of tracking an avoidance course. Also, by selectively performing braking control depending on the situation, microcomputer 510 can reduce the wear of brake pads and thereby ensure functional safety in the long term.

FIG. 9 is a state diagram illustrating a difference in the recognition of a lateral shift amount due to the presence or absence of vehicle slip angle β. The upper part of FIG. 9 shows a state in which an error in the recognition of the lateral shift amount is caused by the occurrence of vehicle slip angle β. The lower part of FIG. 9 shows a state in which the error in the recognition of the lateral shift amount is corrected as a result of control performed to reduce vehicle slip angle β.

When the lateral shift amount from an avoidance course is obtained with reference to the longitudinal direction of vehicle 100, an error in the recognition of the lateral shift amount occurs in a state in which vehicle slip angle β is present and the longitudinal direction of vehicle 100 does not match the vehicle speed vector. In the case of the upper part of FIG. 9, the lateral shift amount is underestimated, and as a result, the performance in tracking the avoidance course is reduced.

In this case, when vehicle slip angle β is brought close to zero, as shown in the lower part of FIG. 9, by applying a counterclockwise yaw moment to vehicle 100 as illustrated in FIG. 9, the longitudinal direction of vehicle 100 matches the vehicle speed vector, and the error in the recognition of the lateral shift amount is reduced.

Correctly recognizing the lateral shift amount from the avoidance course makes it possible to improve the performance in tracking the avoidance course and improve the performance in collision avoidance and damage reduction.

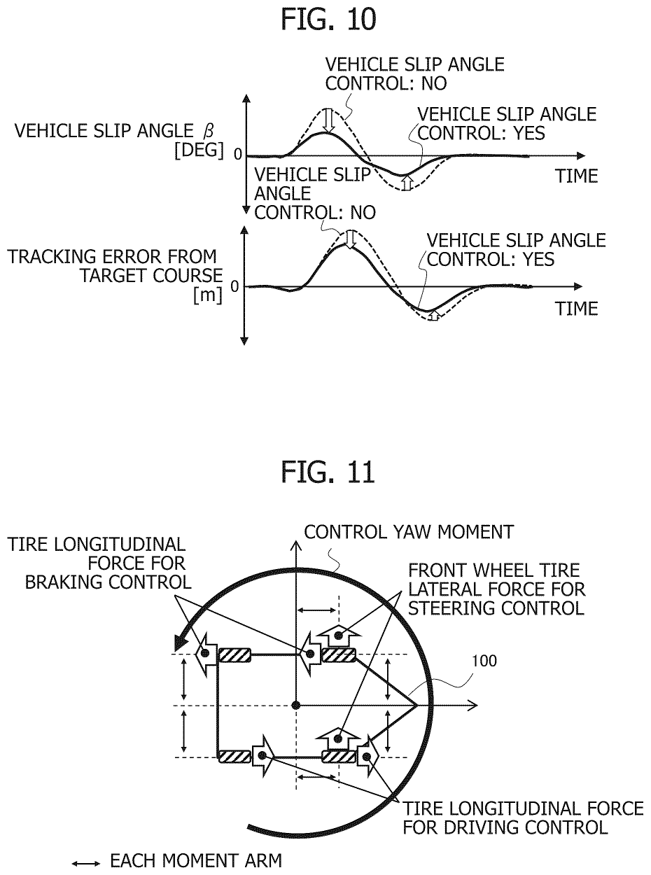

FIG. 10 is a timing chart showing a correlation between vehicle slip angle β and an error in tracking a target course, such as an avoidance course.

The upper part of FIG. 10 shows that vehicle slip angle β is reduced as a result of performing control for reducing vehicle slip angle β. The lower part of FIG. 10 shows that the error in tracking a target course is reduced as a result of reducing vehicle slip angle β.

Thus, by performing vehicle slip angle control for reducing vehicle slip angle β, microcomputer 510 can accurately recognize a lateral shift amount from an avoidance course and improve the performance in tracking the avoidance course.

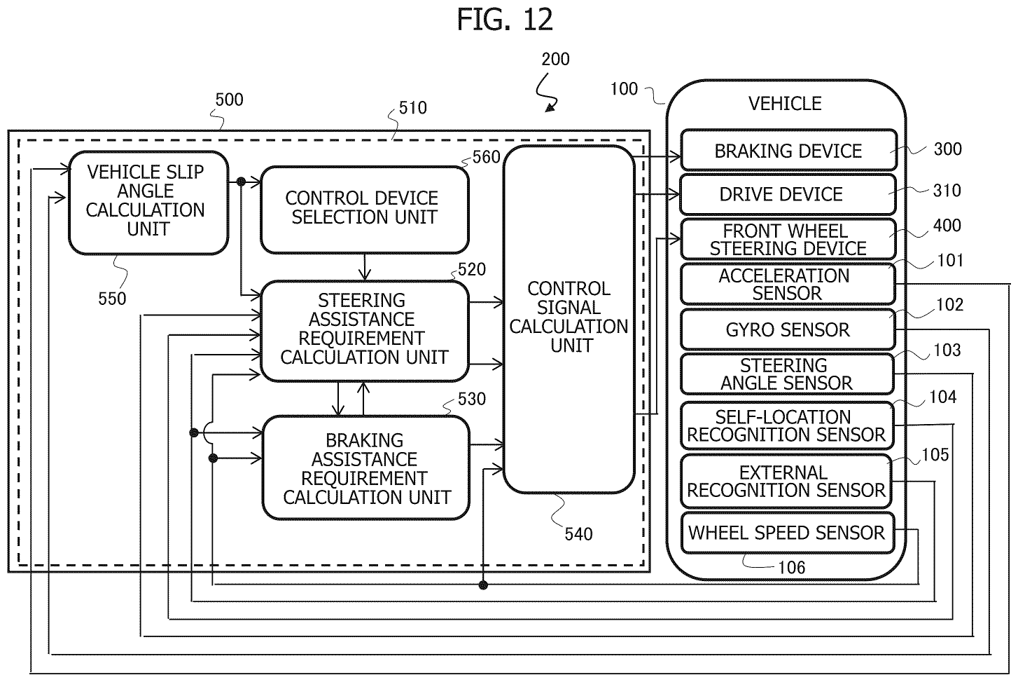

FIG. 11 shows an example of settings of lateral and longitudinal forces required to generate a yaw moment necessary to bring vehicle slip angle β closer to reference angle βTH.

That is, FIG. 11 shows vehicle slip angle control performed in a case in which vehicle slip angle β is brought close to zero by applying, to vehicle 100, a counterclockwise yaw moment, in other words, a yaw moment that causes vehicle 100 to turn to the left.

In this case, a yaw moment that turns vehicle 100 to the left can be applied to vehicle 100 by using a lateral force generated by steering control for steering the front wheels to the left. Also, a yaw moment that turns vehicle 100 to the left can be applied to vehicle 100 by applying braking forces to the left front and rear wheels among the left and right wheels of vehicle 100.

Therefore, at steps S607, S612, and S615 described above, microcomputer 510 sets a steering direction and wheels to which braking forces are applied according to the direction of vehicle slip angle β and sets a steering angle and longitudinal forces (braking forces) according to the magnitude of vehicle slip angle β.

As illustrated in FIG. 11, a yaw moment necessary to bring vehicle slip angle β closer to reference angle βTH can also be applied to vehicle 100 by applying driving forces to the left wheels or the right wheels that are opposite the wheels to which braking forces are applied. For example, when a yaw moment for causing vehicle 100 to turn to the left is to be applied to vehicle 100, driving forces may be applied to the right wheels.

In other words, microcomputer 510 can bring vehicle slip angle β closer to reference angle βTH by controlling not only the braking force of each wheel but also the driving force of each wheel.

### Second Embodiment

A second embodiment is described below. In the second embodiment, microcomputer 510 selects either the steering actuator or the combination of the braking actuator, the driving actuator, and the steering actuator as the control target in vehicle slip angle control for bringing vehicle slip angle β closer to reference angle βTH.

FIG. 12 is a block diagram illustrating a vehicle control system 200 that performs collision avoidance assistance (AEB and ESS) in the second embodiment.

In vehicle control system 200 illustrated in FIG. 12, the same reference numbers as those in vehicle control system 200 of the first embodiment illustrated in FIG. 1 are assigned to the corresponding components, and detailed descriptions of blocks having the same functions as those in FIG. 1 are omitted.

Vehicle control system 200 illustrated in FIG. 12 differs from vehicle control system 200 of the first embodiment illustrated in FIG. 1 in that a drive device 310, which applies a driving force to each of the four wheels, is added as the control target, and that control signal calculation unit 540 also outputs a control signal to drive device 310.

Drive device 310 includes an actuator that is capable of electronically controlling the driving force of each wheel individually by using an electrical signal.

Drive device 310 is a driving actuator among braking and driving actuators for each wheel and applies a driving force to each wheel. Thus, vehicle 100 including drive device 310 is a so-called four-wheel drive vehicle.

Steering assistance requirement calculation unit 520 has a configuration similar to steering assistance requirement calculation unit 520 of the first embodiment (see FIG. 3). However, β-angle minimization requirement calculation unit 521 constituting steering assistance requirement calculation unit 520 calculates braking forces and driving forces for respective wheels as required longitudinal forces in vehicle slip angle control.

For example, when calculating required longitudinal forces of respective wheels required to generate a yaw moment in a direction to decrease vehicle slip angle β, β-angle minimization requirement calculation unit 521 calculates required longitudinal forces for respective wheels such that braking forces are applied to either the left front and rear wheels or the right front and rear wheels and driving forces are applied to the other pair as illustrated in FIG. 11.

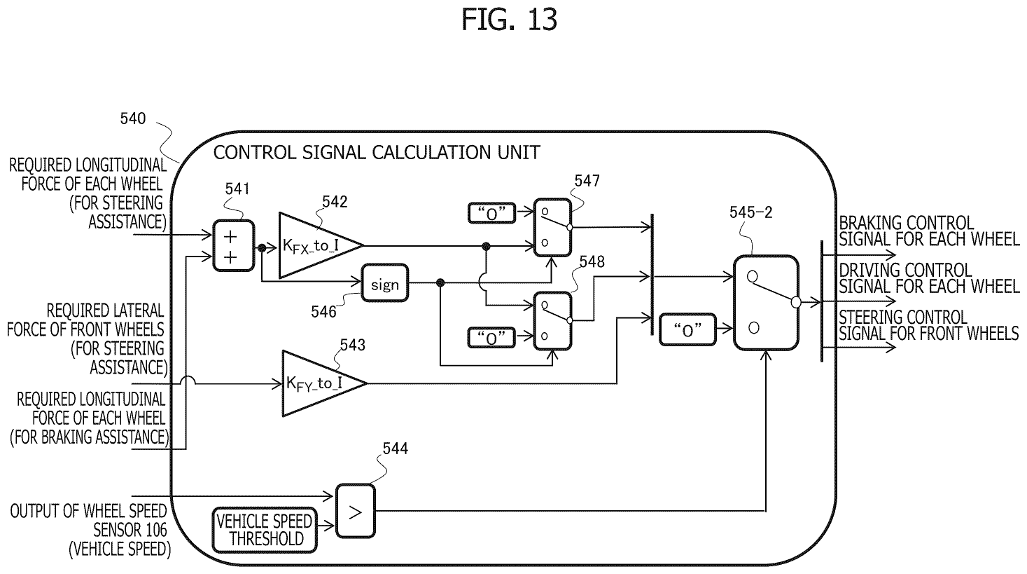

FIG. 13 is a functional block diagram of control signal calculation unit 540 according to the second embodiment.

The same reference numbers as in FIG. 5 illustrating the details of control signal calculation unit 540 of the first embodiment are assigned to the corresponding components in FIG. 13, and detailed descriptions of those components are omitted.

Control signal calculation unit 540 of the second embodiment illustrated in FIG. 13 obtains a signal representing a required longitudinal force of each wheel for steering assistance (ESS) and a signal representing a required lateral force of the front wheels for steering assistance from steering assistance requirement calculation unit 520 and obtains a signal representing a required longitudinal force of each wheel for braking assistance (AEB) from braking assistance requirement calculation unit 530.

Here, the required longitudinal force for steering assistance output by steering assistance requirement calculation unit 520 represents a required driving force when its value is positive and represents a required braking force when its value is negative.

Adding unit 541 obtains the signal representing the required longitudinal force of each wheel for steering assistance and the signal representing the required longitudinal force of each wheel for braking assistance, and outputs the sum of these signals as a required longitudinal force of the corresponding wheel for collision avoidance assistance.

First conversion unit 542 converts the signal representing the required longitudinal force of each wheel for collision avoidance assistance output by adding unit 541 into a braking and driving control signal for the corresponding wheel.

A sign identification unit 546 identifies the sign of the required longitudinal force of each wheel for collision avoidance assistance output from adding unit 541 and thereby determines whether the required longitudinal force is a braking request or a driving request for each wheel.

A braking signal switching unit 547 obtains the braking and driving control signal for each wheel from first conversion unit 542 and obtains a signal indicating the result of the sign identification from sign identification unit 546.

When the sign of the required longitudinal force of each wheel for collision avoidance assistance output from adding unit 541 is positive, that is, when the required longitudinal force for collision avoidance assistance is a required driving force, braking signal switching unit 547 outputs a braking control signal representing zero, i.e., a signal indicating that there is no braking request for collision avoidance assistance.

On the other hand, when the sign of the required longitudinal force of each wheel for collision avoidance assistance output from adding unit 541 is negative, that is, when the required longitudinal force for collision avoidance assistance is a required braking force, braking signal switching unit 547 outputs the braking and driving control signal output from first conversion unit 542 as a braking control signal.

A drive signal switching unit 548 also obtains the braking and driving control signal for each wheel from first conversion unit 542 and obtains the signal indicating the result of the sign identification from sign identification unit 546.

When the sign of the required longitudinal force of each wheel for collision avoidance assistance output from adding unit 541 is negative, that is, when the required longitudinal force for collision avoidance assistance is a required braking force, drive signal switching unit 548 outputs a drive control signal representing zero, i.e., a signal indicating that there is no driving request for collision avoidance assistance.

On the other hand, when the sign of the required longitudinal force of each wheel for collision avoidance assistance output from adding unit 541 is positive, that is, when the required longitudinal force for collision avoidance assistance is a required driving force, drive signal switching unit 548 outputs the braking and driving control signal output from first conversion unit 542 as a drive control signal.

That is, sign identification unit 546, braking signal switching unit 547, and drive signal switching unit 548 output a braking control signal or a drive control signal for each wheel depending on whether the required longitudinal force for collision avoidance assistance, which is obtained by adding the required longitudinal force for steering assistance to the required longitudinal force for braking assistance, is a required braking force or a required driving force.

Second conversion unit 543 obtains a signal representing a required lateral force of the front wheels for steering assistance and converts the signal representing the required lateral force of the front wheels for steering assistance into a steering control signal for the front wheels.

Comparison unit 544 obtains a signal representing a vehicle speed that is based on the output of wheel speed sensor 106, compares the obtained signal representing the vehicle speed with a threshold, and outputs a switching signal for switching between outputting or not outputting a required value for collision avoidance assistance.

A switching unit 545-2 obtains the braking control signal for each wheel output from braking signal switching unit 547, the drive control signal for each wheel output from drive signal switching unit 548, the steering control signal for each front wheel output from second conversion unit 543, and a switching signal output from comparison unit 544.

Based on the switching signal output from comparison unit 544, a switching unit 545-2 switches between outputting or not outputting the braking control signal, the drive control signal, and the steering control signal to the downstream devices (braking device 300, drive device 310, and front wheel steering device 400).

Here, vehicle control system 200 is configured to not output the braking control signal, the drive control signal, and the steering control signal to the downstream devices in the slow state in which the vehicle speed is less than or equal to a threshold and to output the braking control signal, the drive control signal, and the steering control signal to the downstream devices in a state in which the vehicle speed is greater than the threshold.

That is, when the vehicle speed is low, control signal calculation unit 540 stops the braking control, the drive control, and the steering control for collision avoidance assistance because the effectiveness of collision avoidance assistance is low.

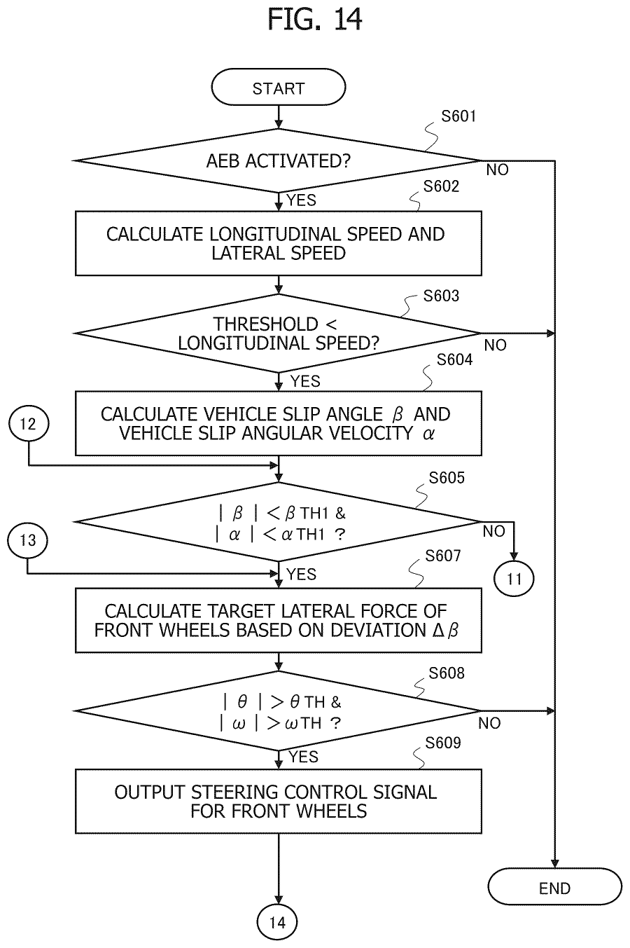

Flowcharts in FIGS. 14-16 illustrate a control target selection process performed by control device selection unit 560 and a vehicle slip angle control process performed by β-angle minimization requirement calculation unit 521 according to the second embodiment.

In the second embodiment, β-angle minimization requirement calculation unit 521 obtains a required braking force or a required driving force for each wheel as a required longitudinal force required to obtain a yaw moment necessary to bring vehicle slip angle β to reference angle βTH.

The control target selection process performed by control device selection unit 560 in the second embodiment is the same as that in the first embodiment.

Therefore, the processes illustrated in the flowcharts of FIGS. 14-16 are different from the processes illustrated in the flowcharts of FIGS. 6-8 of the first embodiment only in steps S612-2 and S615-2.

Therefore, the same step numbers as in the flowcharts of FIGS. 6-8 are assigned to steps other than steps S612-2 and S615-2, and detailed descriptions of these steps are omitted.

When determining at step S606 that the conditions, defining that the absolute value of vehicle slip angle β is greater than first threshold βTH1 and is less than second threshold βTH2 and the absolute value of vehicle slip angular velocity α is greater than threshold βTH1, are satisfied, microcomputer 510 proceeds to step S610.

At step S610, based on deviation Δβ between vehicle slip angle β and reference angle βTH, microcomputer 510 calculates a required lateral force of the front wheels and a required longitudinal force (a required braking force or a required driving force) of each wheel that are required to generate a yaw moment necessary to bring vehicle slip angle β0 closer to reference angle βTH.

When determining at step S611 that a steering operation has been performed by the driver as a trigger to start ESS, microcomputer 510 proceeds to step S612-2.

At step S612-2, microcomputer 510 outputs a steering control signal for the front wheels to front wheel steering device 400 based on the required lateral force of the front wheels calculated at step S610, outputs a braking control signal for each wheel to braking device 300 based on the required longitudinal force (required braking force or required driving force) of each wheel calculated at step S610, and outputs a drive control signal for each wheel to drive device 310.

When determining at step S606 that the conditions, defining that the absolute value of vehicle slip angle β is greater than first threshold βTH1 and is less than second threshold βTH2 and the absolute value of vehicle slip angular velocity α is greater than threshold αTH1, are not satisfied, microcomputer 510 proceeds to step S613.

Then, at step S613, microcomputer 510 calculates a required lateral force of the front wheels and a required longitudinal force (required braking force or required driving force) of each rear wheel that are required to generate a yaw moment necessary to bring vehicle slip angle β closer to reference angle βTH based on deviation Δβ between vehicle slip angle ß and reference angle βTH.

Next, when determining at step S614 that a steering operation has been performed by the driver as a trigger to start ESS, microcomputer 510 proceeds to step S615-2.

At step S615-2, microcomputer 510 outputs a steering control signal for the front wheels to front wheel steering device 400 based on the required lateral force of the front wheels calculated at step S613, outputs a braking control signal for each rear wheel to braking device 300 based on the required longitudinal force (required braking force or required driving force) of the corresponding rear wheel calculated at step S613, and outputs a drive control signal for each rear wheel to drive device 310.

According to the second embodiment described above, when both of the steering actuator and the braking and driving actuators are selected as the control target in vehicle slip angle control, both of the braking actuator and the driving actuator among the braking and driving actuators are selected.

Accordingly, compared with the first embodiment in which only the braking actuator is selected out of the braking and driving actuators, the second embodiment makes it possible to more easily generate a yaw moment necessary to bring vehicle slip angle β closer to predetermined reference angle βTH and to stably maintain the accuracy of tracking an avoidance course.

### Third Embodiment

Here, when vehicle 100 includes a rear wheel steering device in addition to front wheel steering device 400, the rear wheel steering device may be included as the control target in vehicle slip angle control for generating a yaw moment necessary to bring vehicle slip angle β closer to reference angle βTH.

A third embodiment, in which a rear wheel steering device is included as the control target in vehicle slip angle control, is described below.

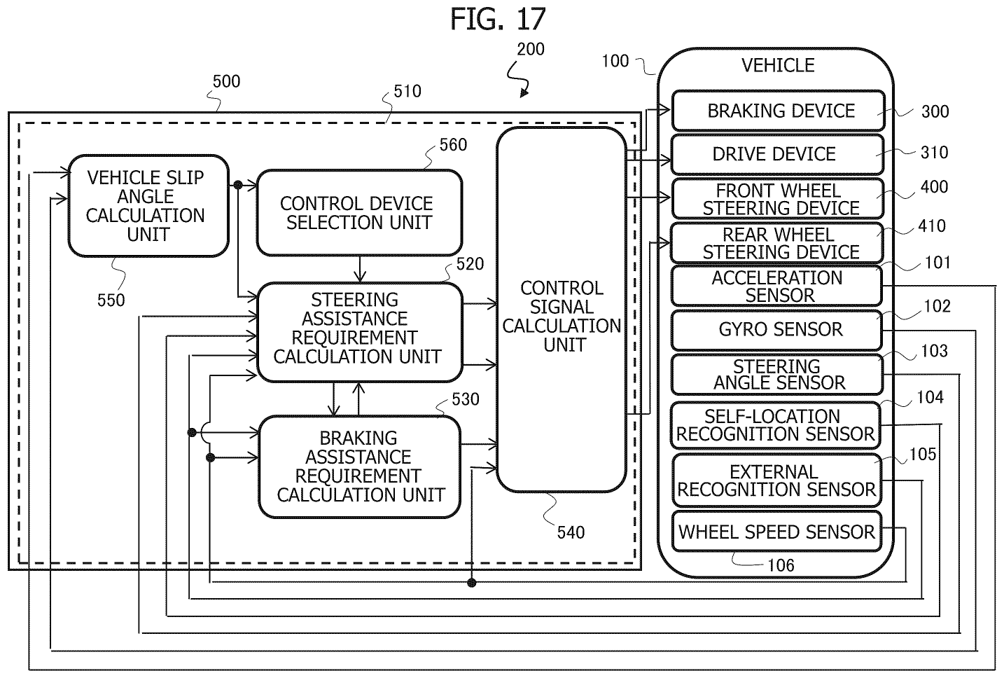

FIG. 17 is a block diagram illustrating a vehicle control system 200 that performs collision avoidance assistance (AEB and ESS) according to the third embodiment.

In vehicle control system 200 illustrated in FIG. 17, the same reference numbers as those in vehicle control system 200 illustrated in FIG. 12 are assigned to the corresponding components, and detailed descriptions of blocks having the same functions as those in FIG. 12 are omitted.

Vehicle control system 200 illustrated in FIG. 17 differs from vehicle control system 200 of the second embodiment illustrated in FIG. 12 in that a rear wheel steering device 410 is added as the control target, and control signal calculation unit 540 outputs a control signal also to rear wheel steering device 410.

Rear wheel steering device 410 includes an actuator that can electronically control the steering angle of the rear wheels with an electrical signal.

In the present application, steering actuators include a front wheel steering actuator and a rear wheel steering actuator, front wheel steering device 400 corresponds to the front wheel steering actuator among the steering actuators, and rear wheel steering device 410 corresponds to the rear wheel steering actuator among the steering actuators.

Vehicle 100 of the third embodiment includes front wheel steering device 400 as a front wheel steering actuator and rear wheel steering device 410 as a rear wheel steering actuator.

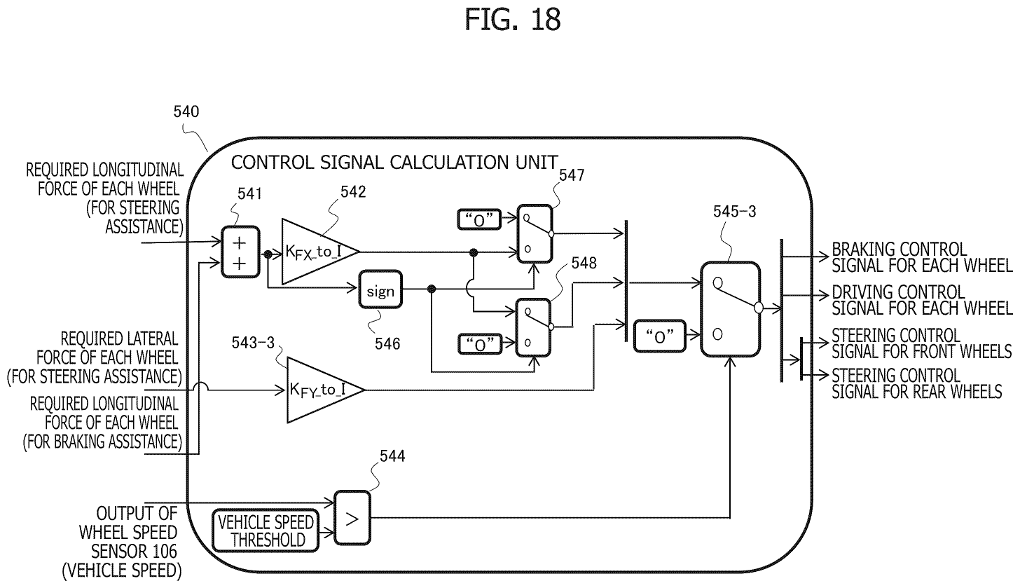

FIG. 18 is a functional block diagram of control signal calculation unit 540 according to the third embodiment.

The same reference numbers as in FIG. 13 illustrating the details of control signal calculation unit 540 of the second embodiment are assigned to the corresponding components in FIG. 18, and detailed descriptions of these components are omitted.

Control signal calculation unit 540 of the third embodiment illustrated in FIG. 18 obtains a signal representing the required longitudinal force (the required braking force or the required driving force) of each wheel for steering assistance and a signal representing the required lateral force of each wheel (the required lateral force of the front wheels or the required lateral force of the rear wheels) for steering assistance from steering assistance requirement calculation unit 520, and obtains a signal representing the required longitudinal force (the required braking force) of each wheel for braking assistance from braking assistance requirement calculation unit 530.

A second conversion unit 543-3 converts the signals representing the required lateral forces of respective wheels (the front and rear wheels) for steering assistance into a steering control signal for the front wheels and a steering control signal for the rear wheels.

In the slow state in which the vehicle speed is less than or equal to a threshold, a switching unit 545-3 outputs the braking and driving control signals for the respective wheels and the steering control signals for the front and rear wheels that indicate zero and thereby stops braking and driving control and steering control for AEB and ESS.

When the vehicle speed is greater than the threshold, switching unit 545-3 activates AEB and ESS by outputting the braking and driving control signals of the respective wheels and the steering control signals of the front and rear wheels to the downstream devices without change.

Control signal calculation unit 540 outputs the braking control signals for the respective wheels to braking device 300, outputs the drive control signals for the respective wheels to drive device 310, outputs the steering control signal for the front wheels to front wheel steering device 400, and outputs the steering control signal for the rear wheels to rear wheel steering device 410.

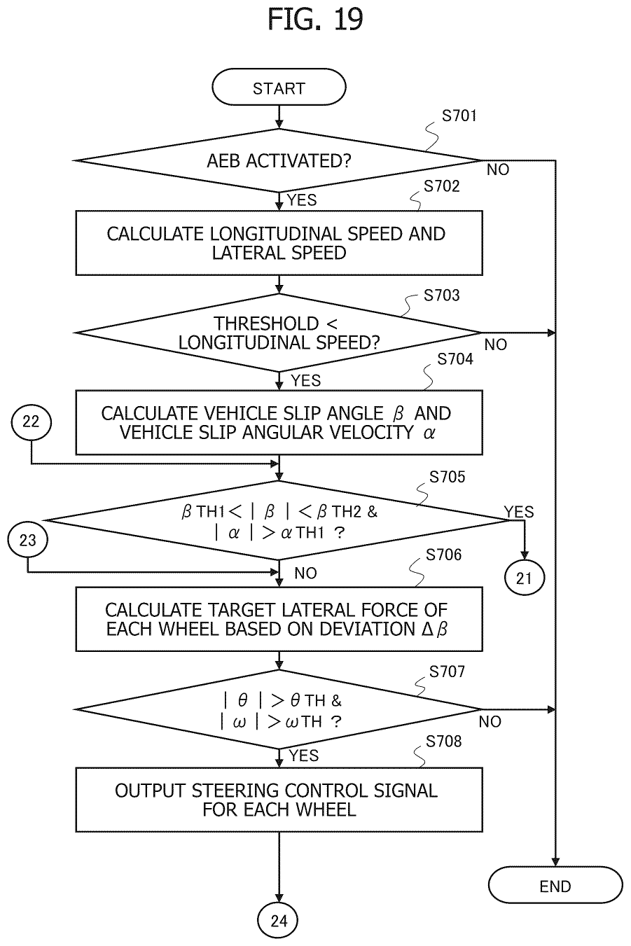

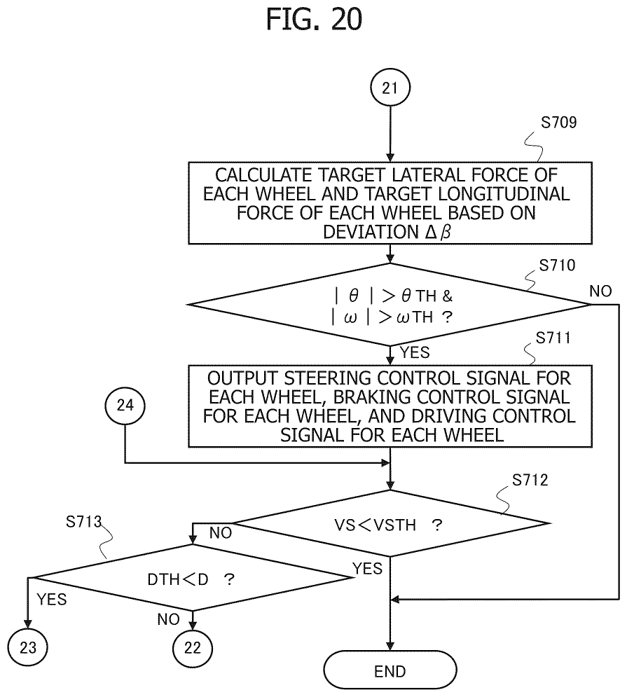

Flowcharts in FIGS. 19 and 20 illustrate a control target selection process performed by control device selection unit 560 and a vehicle slip angle control process performed by β-angle minimization requirement calculation unit 521 according to the third embodiment.

In the third embodiment, microcomputer 510 selects the control target in vehicle slip angle control based on a selection condition that the absolute value of vehicle slip angle β is greater than first threshold βTH1 and is less than second threshold βTH2 (where βTH2>βTH1>0) and the absolute value of vehicle slip angular velocity α is greater than threshold αTH1.

Based on whether the selection condition is satisfied, microcomputer 510 selectively switches the control target in vehicle slip angle control between the combination of front wheel steering device 400 and rear wheel steering device 410 (in other words, only the steering actuators) and the combination of four devices including front wheel steering device 400, rear wheel steering device 410, braking device 300, and drive device 310 (in other words, both of the steering actuators and the braking and driving actuators).

At steps S701-S704 in the flowcharts of FIGS. 19 and 20, microcomputer 510 performs processes similar to steps S601-S604 described above.

At step S705, microcomputer 510 determines whether conditions, defining that the absolute value of vehicle slip angle β is greater than first threshold βTH1 and is less than second threshold βTH2 and the absolute value of vehicle slip angular velocity α is greater than threshold αTH1, are satisfied.

When determining at step S705 that the conditions are not satisfied, microcomputer 510 proceeds to step S706.

At step S706, based on deviation Δβ between vehicle slip angle β and reference angle βTH, microcomputer 510 calculates a required lateral force of the front wheels and a required lateral force of the rear wheels that are required to generate a yaw moment necessary to bring vehicle slip angle β closer to reference angle βTH.

Next, at step S707, microcomputer 510 determines whether steering angle θ of the front wheels steered by the driver is greater than threshold θTH and whether steering angular velocity ω is greater than threshold ωTH.

When the conditions for activating ESS are satisfied, that is, when steering angle θ is greater than threshold θTH and steering angular velocity ω is greater than threshold ωTH, microcomputer 510 proceeds to step S708.

At step S708, microcomputer 510 outputs a steering control signal for the front wheels to front wheel steering device 400 based on the required lateral force of the front wheels, and outputs a steering control signal for the rear wheels to rear wheel steering device 410 based on the required lateral force of the rear wheels.

In other words, when the conditions, defining that the absolute value of vehicle slip angle β is greater than first threshold βTH1 and is less than second threshold βTH2 and the absolute value of vehicle slip angular velocity α is greater than threshold αTH1, are not satisfied, microcomputer 510 selects front wheel steering device 400 and rear wheel steering device 410 (in other words, the steering actuators including the front wheel steering actuator and the rear wheel steering actuator) as the control target in vehicle slip angle control.

When the conditions, defining that the absolute value of vehicle slip angle β is greater than first threshold βTH1 and is less than second threshold βTH2 and the absolute value of vehicle slip angular velocity α is greater than threshold αTH1, are not satisfied, it is presumed that a yaw moment necessary to bring vehicle slip angle β closer to predetermined reference angle βTH can be generated only by the lateral forces of the respective wheels generated by front wheel steering control and rear wheel steering control or that the tire lateral force is saturated and it is not possible to generate a tire longitudinal force.

Therefore, when the conditions, defining that the absolute value of vehicle slip angle β is greater than first threshold βTH1 and is less than second threshold βTH2 and the absolute value of vehicle slip angular velocity α is greater than threshold αTH1, are not satisfied, microcomputer 510 selects steering actuators including front wheel steering device 400 and rear wheel steering device 410 as the control target in vehicle slip angle control.

On the other hand, when determining at step S705 that the conditions, defining that the absolute value of vehicle slip angle β is greater than first threshold βTH1 and is less than second threshold βTH2 and the absolute value of vehicle slip angular velocity α is greater than threshold αTH1, are satisfied, microcomputer 510 proceeds to step S709.

At step S709, based on deviation Δβ between vehicle slip angle β and reference angle βTH, microcomputer 510 calculates the required lateral force of the front wheels, the required lateral force of the rear wheels, and the required longitudinal forces (the required braking force and the required driving force) of the respective wheels that are required to generate a yaw moment necessary to bring vehicle slip angle β closer to reference angle βTH.

Next, microcomputer 510 proceeds to step S710 and, similarly to step S707, determines whether conditions, defining that steering angle θ is greater than threshold θTH and steering angular velocity ω is greater than threshold ωTH, are satisfied.

When steering angle θ is greater than threshold θTH and steering angular velocity ω is greater than threshold ωTH, microcomputer 510 determines that the conditions for activating ESS are satisfied and proceeds to step S711.

At step S711, microcomputer 510 outputs a steering control signal for the front wheels to front wheel steering device 400 based on the required lateral force of the front wheels, outputs a steering control signal for the rear wheels to rear wheel steering device 410 based on the required lateral force of the rear wheels, outputs braking control signals for the respective wheels to braking device 300 based on the required braking forces of the respective wheels, and outputs drive control signals for the respective wheels to drive device 310 based on the required driving forces of the respective wheels.

Also, after step S708 or step S711, microcomputer 510 proceeds to step S712 to compare vehicle speed VS with threshold VSTH.

When vehicle speed VS is less than threshold VSTH, microcomputer 510 ends vehicle slip angle control. When vehicle speed VS is greater than or equal to threshold VSTH, microcomputer 510 proceeds to step S713.

At step S713, microcomputer 510 determines whether distance D from vehicle 100 to the obstacle ahead is greater than threshold DTH.

When determining at step S713 that distance D to the obstacle is greater than threshold DTH, microcomputer 510 proceeds to step S706 to bring vehicle slip angle β closer to reference angle βTH by performing steering control using front wheel steering device 400 and rear wheel steering device 410.

On the other hand, when distance D to the obstacle is less than or equal to threshold DTH, microcomputer 510 proceeds to step S705 to select the control target based on vehicle slip angle β and vehicle slip angular velocity α.

In the third embodiment described above, microcomputer 510 selects, as the control target in vehicle slip angle control, only the steering actuators including front wheel steering device 400 and rear wheel steering device 410 or the combination of the steering actuators and the braking and driving actuators including braking device 300 and drive device 310 based on whether the absolute value of vehicle slip angle β is greater than first threshold βTH1 and is less than second threshold βTH2 and whether the absolute value of vehicle slip angular velocity α is greater than threshold αTH1.

According to the third embodiment, both front wheel steering device 400 and rear wheel steering device 410 are selected as the steering control target in vehicle slip angle control. This makes it possible to expand the range in which vehicle slip angle control can be implemented only by steering control and to prevent unstable behavior of vehicle 100.

### Fourth Embodiment

Microcomputer 510 can predict future vehicle slip angle β and select the control target in vehicle slip angle control based on a predicted vehicle slip angle βes.

In a fourth embodiment described below, the control target in vehicle slip angle control is selected based on predicted vehicle slip angle βes.

The fourth embodiment differs from the first embodiment in that the process of selecting the control target in vehicle slip angle control is performed based on predicted vehicle slip angle βes instead of vehicle slip angle β.

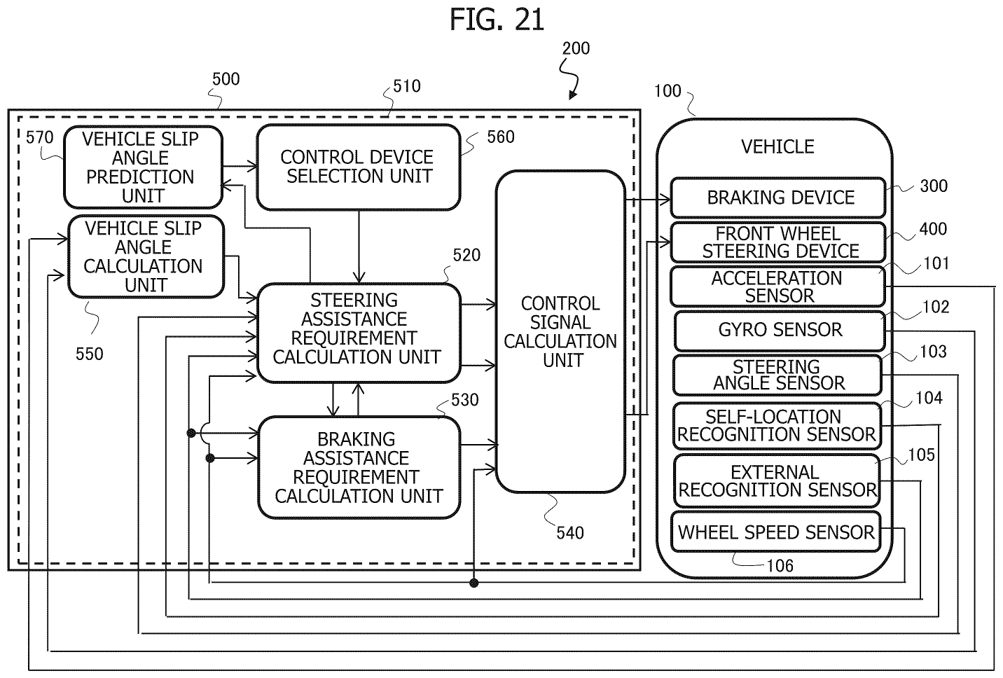

FIG. 21 is a block diagram illustrating a vehicle control system 200 that performs collision avoidance assistance (AEB and ESS) according to the fourth embodiment.

In vehicle control system 200 illustrated in FIG. 21, the same reference numbers as those in vehicle control system 200 of the first embodiment illustrated in FIG. 1 are assigned to corresponding components, and detailed descriptions of blocks having the same functions as those in FIG. 1 are omitted.

Vehicle control system 200 illustrated in FIG. 21 differs from vehicle control system 200 of the first embodiment illustrated in FIG. 1 in that a vehicle slip angle prediction unit 570 is added.

Vehicle slip angle prediction unit 570 obtains information on the azimuth angle of an avoidance course from steering assistance requirement calculation unit 520 and outputs information on predicted vehicle slip angle βes to control device selection unit 560.

Here, vehicle slip angle prediction unit 570 calculates predicted vehicle slip angle βes, which is a future vehicle slip angle β, based on the rate of change over time of the azimuth angle of the avoidance course.

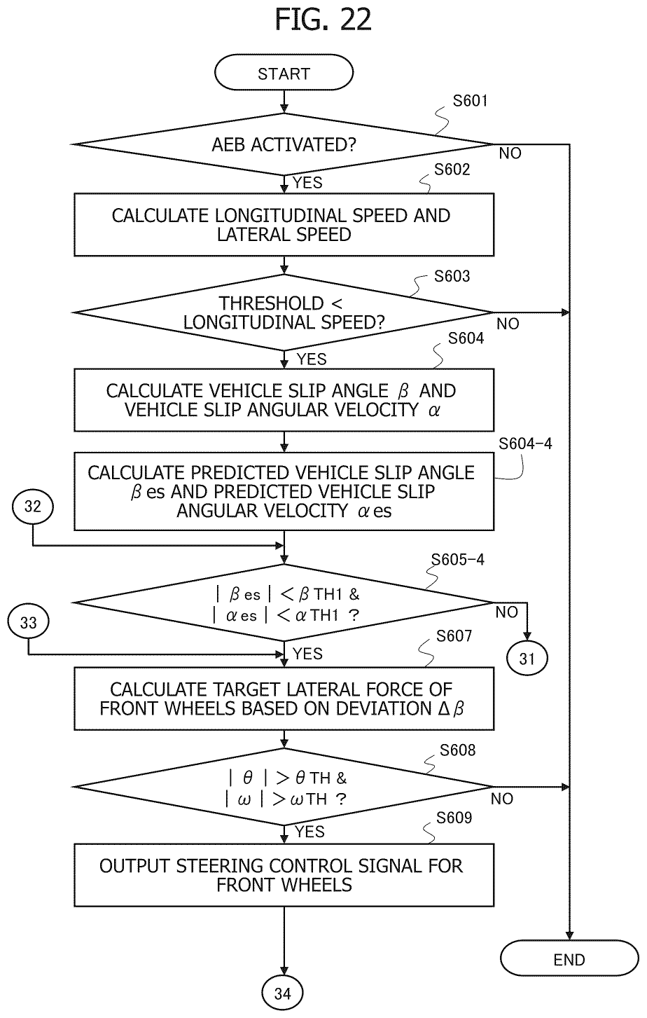

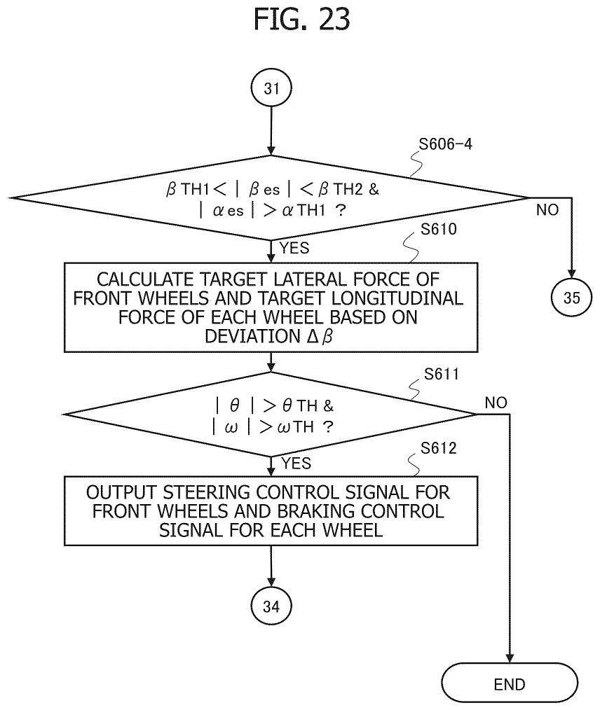

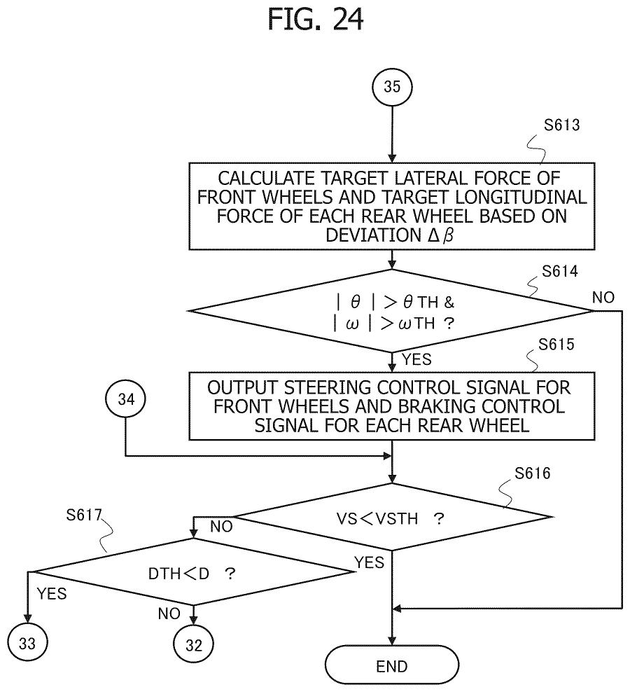

Flowcharts in FIGS. 22-24 illustrate a control target selection process performed by control device selection unit 560 and a vehicle slip angle control process performed by β-angle minimization requirement calculation unit 521 according to the fourth embodiment.

The flowcharts of FIGS. 22-24 differ from the flowcharts of FIGS. 6-8 of the first embodiment in that step S604-4 for obtaining predicted vehicle slip angle βes and a predicted vehicle slip angular velocity αes is added and also differ in that, at steps S605-4 and S606-4, first threshold βTH1 and second threshold βTH2 are compared with predicted vehicle slip angle βes, and threshold αTH1 is compared with predicted vehicle slip angular velocity αes.

After calculating vehicle slip angle β and vehicle slip angular velocity α at step S604, microcomputer 510 proceeds to step S604-4.

At step S604-4, microcomputer 510 calculates the time rate of change of the azimuth angle of the avoidance course, calculates predicted vehicle slip angle βes, which is a future vehicle slip angle β, based on the time rate of change of the azimuth angle of the avoidance course, and calculates predicted vehicle slip angular velocity αes by taking the time derivative of predicted vehicle slip angle βes.

At step S605-4, microcomputer 510 determines whether the absolute value of predicted vehicle slip angle βes is less than first threshold ββTH1 and the absolute value of predicted vehicle slip angular velocity αes is less than threshold αTH1.

Also, at step S606-4, microcomputer 510 determines whether the absolute value of predicted vehicle slip angle βes is greater than first threshold βTH1 and is less than second threshold βTH2 and whether the absolute value of predicted vehicle slip angular velocity αes is greater than threshold αTH1.

That is, in the fourth embodiment, microcomputer 510 selectively switches the control target in vehicle slip angle control based on future vehicle slip angle βes and future vehicle slip angular velocity αes instead of current vehicle slip angle β and current vehicle slip angular velocity α.

According to the fourth embodiment, the control target in vehicle slip angle control is switched based on predicted vehicle slip angle βes that is expected to occur in the future.

This makes it possible to preemptively and appropriately switch the control target by predicting changes in vehicle slip angle β and thereby makes it possible to reduce the response delay in vehicle slip angle control.

The technical concepts described in the above embodiments may be used in any appropriate combination as long as they do not conflict with each other.

Although the present invention is specifically described above with reference to preferred embodiments, it is apparent to one skilled in the art that variations of the embodiments can be made based on the basic technical concepts and the teachings of the present invention.

In the above embodiments, collision avoidance assistance is performed by the combination of AEB and ESS, and control to reduce vehicle slip angle β is performed to improve the performance of tracking an avoidance course generated in response to a steering operation performed by the driver. However, collision avoidance assistance is not limited to the combination of AEB and ESS.

For example, microcomputer 510 may perform vehicle slip angle control to reduce vehicle slip angle β when performing control to cause vehicle 100 to follow an avoidance course that is automatically generated based on information from external recognition sensor 105.

Also, microcomputer 510 may be changed from a configuration in which only steering actuators are selected as the control target in vehicle slip angle control that is performed to bring vehicle slip angle β closer to reference angle βTH.

For example, microcomputer 510 may be configured to select only the steering actuators as the control target when vehicle slip angle β is less than first threshold βTH1, select both the steering actuators and the braking and driving actuators as the control target when vehicle slip angle β is greater than or equal to first threshold βTH1 and greater than or equal to second threshold βTH2, and select only the steering actuators or both of the steering actuators and the braking and driving actuators of the rear wheels as the control target when vehicle slip angle β is greater than second threshold βTH2.

In other words, microcomputer 510 can gradually change the control target as vehicle slip angle β increases.

Also, when selecting the control target in vehicle slip angle control from two options based on conditions defining that the absolute value of vehicle slip angle β is greater than first threshold βTH1 and is less than second threshold βTH2 and the absolute value of vehicle slip angular velocity α is greater than threshold αTH1 as in the third embodiment, microcomputer 510 may select actuators that are different from the third embodiment as the control target.

For example, microcomputer 510 may select only front wheel steering device 400 as the control target when the conditions, defining that the absolute value of vehicle slip angle β is greater than first threshold βTH1 and is less than second threshold βTH2 and the absolute value of vehicle slip angular velocity α is greater than threshold αTH1, are not satisfied.

Also, microcomputer 510 my select a combination of front wheel steering device 400 and braking device 300 or a combination of front wheel steering device 400 and a braking and driving device of the rear wheels when conditions, defining that the absolute value of vehicle slip angle β is greater than first threshold βTH1 and is less than second threshold βTH2 and the absolute value of vehicle slip angular velocity α is greater than threshold αTH1, are satisfied.

Even in the control target switching process of the second embodiment illustrated in the flowcharts of FIGS. 14-16 and in the control target switching process of the third embodiment illustrated in the flowcharts of FIGS. 19 and 20, as in the fourth embodiment, microcomputer 510 may compare predicted vehicle slip angle βes, instead of vehicle slip angle β, with first threshold βTH1 and second threshold βTH2 and compare predicted vehicle slip angular velocity αes, instead of vehicle slip angular velocity α, with threshold αTH1.

Microcomputer 510 may stop vehicle slip angle control when vehicle slip angle β is less than a set value.

Microcomputer 510 may also selectively switch the control target in vehicle slip angle control for bringing vehicle slip angle β closer to reference angle βTH based on physical quantities, such as a tire slip angle and a yaw rate, resulting from the tire forces of vehicle 100.

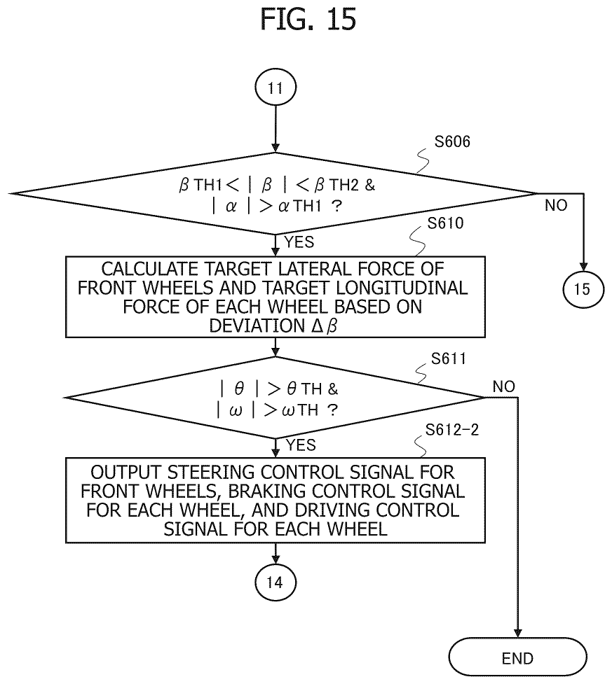

In the second embodiment, when vehicle 100 is a rear-wheel drive vehicle and drive device 310 applies a driving force only to the rear wheels, microcomputer 510 may output a drive control signal for the rear wheels at step S612-2 in FIG. 15.

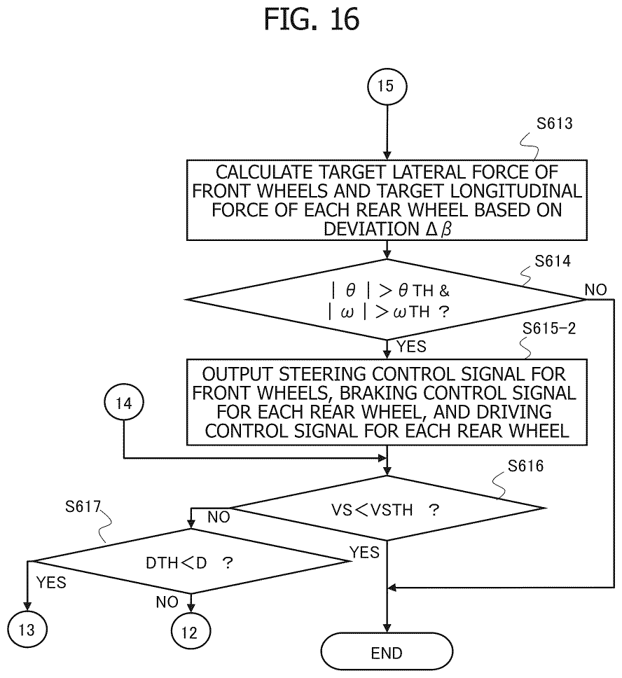

Also, in the second embodiment, when vehicle 100 is a front-wheel drive vehicle and drive device 310 applies a driving force only to the front wheels, microcomputer 510 may be configured to not perform driving force control for the wheels at step S612-2 in FIG. 15 and step S615-2 in FIG. 16.

### REFERENCE SYMBOL LIST

100 . . . vehicle, 200 . . . vehicle control system, 300 . . . braking device (braking and driving actuator, braking actuator), 400 . . . front wheel steering device (steering actuator), 500 . . . vehicle control device, 510 . . . microcomputer (control unit, controller), 520 . . . steering assistance requirement calculation unit, 530 . . . braking assistance requirement calculation unit, 540 . . . control signal calculation unit, 550 . . . vehicle slip angle calculation unit, 560 control device selection unit, β . . . vehicle slip angle (first angle)

1. A vehicle control device for a vehicle including braking and driving actuators that apply braking and driving forces to wheels and a steering actuator that steers the wheels, the vehicle control device comprising a control unit that:
obtains a first angle between an orientation of the vehicle and a travel direction of the vehicle,
obtains an avoidance course for avoiding an object located ahead of the vehicle,
performs first angle control of bringing the first angle closer to a predetermined reference angle when performing course tracking control to cause the vehicle to follow the avoidance course, and
selects either the steering actuator alone or a combination of the steering actuator and at least one of the braking and driving actuators as a control target in the first angle control based on a physical quantity resulting from tire forces of the vehicle.

2. The vehicle control device according to claim 1, wherein the control unit obtains a physical quantity related to the first angle as the physical quantity resulting from the tire forces of the vehicle.

3. The vehicle control device according to claim 2, wherein the control unit obtains at least one of the first angle and an angular velocity of the first angle as the physical quantity related to the first angle.

4. The vehicle control device according to claim 3, wherein the control unit:
uses, as selection conditions for selecting the control target in the first angle control, conditions defining that the first angle is greater than a predetermined first angle threshold and is less than a predetermined second angle threshold greater than the first angle threshold and that the angular velocity of the first angle is less than a predetermined angle threshold,
selects the combination of the steering actuator and at least one of the braking and driving actuators as the control target in the first angle control when the selection conditions are satisfied, and
selects the steering actuator as the control target in the first angle control when the selection conditions are not satisfied.

5. The vehicle control device according to claim 4, wherein the control unit obtains the first angle and the angular speed of the first angle when a longitudinal speed of the vehicle is greater than a predetermined longitudinal speed threshold.

6. The vehicle control device according to claim 1, wherein the control unit performs the first angle control when a steering angle corresponding to an operation performed by a driver of the vehicle is greater than a predetermined steering angle threshold and an angular velocity of the steering angle is greater than a predetermined steering angular velocity threshold.

7. The vehicle control device according to claim 1, wherein the control unit ends the first angle control when a speed of the vehicle becomes less than a predetermined vehicle speed threshold after starting the first angle control.

8. The vehicle control device according to claim 1, wherein the control unit selects, as the control target in the first angle control, either the steering actuator alone or both of a braking actuator among the braking and driving actuators that applies a braking force to the wheels and the steering actuator based on the physical quantity resulting from the tire forces of the vehicle.

9. The vehicle control device according to claim 1, wherein based on the physical quantity resulting from the tire forces of the vehicle, the control unit selects, as the control target in the first angle control, either the steering actuator alone or three actuators including a braking actuator among the braking and driving actuators that applies a braking force to the wheels, a driving actuator among the braking and driving actuators that applies a driving force to the wheels, and the steering actuator.

10. The vehicle control device according to claim 1, wherein the reference angle is zero.

11 .A vehicle control method performed by a control unit for a vehicle including braking and driving actuators that apply braking and driving forces to wheels and a steering actuator that steers the wheels, the vehicle control method comprising:
obtaining a first angle between an orientation of the vehicle and a travel direction of the vehicle;
obtaining an avoidance course for avoiding an object located ahead of the vehicle;
performing first angle control of bringing the first angle closer to a predetermined reference angle when performing course tracking control to cause the vehicle to follow the avoidance course; and
selecting either the steering actuator alone or a combination of the steering actuator and at least one of the braking and driving actuators as a control target in the first angle control based on a physical quantity resulting from tire forces of the vehicle.

12. A vehicle control system comprising:
braking and driving actuators that apply braking and driving forces to wheels of a vehicle;
a steering actuator that steers the wheels; and
a control unit for the vehicle, wherein
the control unit:
obtains a first angle between an orientation of the vehicle and a travel direction of the vehicle,
obtains an avoidance course for avoiding an object located ahead of the vehicle,
performs first angle control of bringing the first angle closer to a predetermined reference angle when performing course tracking control to cause the vehicle to follow the avoidance course, and
selects either the steering actuator alone or a combination of the steering actuator and at least one of the braking and driving actuators as a control target in the first angle control based on a physical quantity resulting from tire forces of the vehicle.
